(19) United States
(12) Patent Application Publication
(10) Pub. No.: US 2015/0304698 A1
(43) Pub. Date: Oct. 22, 2015

(54) Dynamic Interactive Advertisement Insertion

(71) Applicant: Eyesee, Lda, Lisbon (PT)

(72) Inventor: Joao Vasco de Oliveira Redol, Lisboa (PT)

(21) Appl. No.: 14/257,834

(22) Filed: Apr. 21, 2014

(51) Int. Cl. H04N 21/2668; H04N 21/475; H04N 21/262; H04N 21/254

(52) U.S. Cl. CPC H04N 21/2668; H04N 21/254; H04N 21/4758; H04N 21/26208

(57) ABSTRACT

A technology for an advertisement insertion system that is operable to dynamically inserting an advertisement into video content. One or more viable advertisement insertion areas (VAIAs) can be determined in a video content using advertisement criteria. One or more advertisements can be for inserting into the video content. The one or more VAIAs can be determined to insert the one or more selected advertisements into the video content. The one or more advertisements can be inserted at the one or more determined VAIAs into the video content.

### BACKGROUND

Advertisements can be a major source of revenue for companies. There are many places for advertisers to promote a product or service. For example, companies can advertise a product or service in a magazine, in direct mailings, on television, in newspapers, or on the Internet. When advertising a product or service, companies desire to capture the attention of viewers by placing advertisements where the advertisements will be viewed without being intrusive or annoying the viewers, i.e. negatively affecting the image of the product or service being advertised.

One main place for advertisers to promote products is in videos. For example, streaming videos continue to increase as a source that viewers use to watch videos and web-based video advertising is a space that advertisers are increasingly using to promote products. Placement of advertisements in videos, such as web-based videos, is often in a fixed location, such as a banner on a top or bottom of a screen or a box in a corner of the screen.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure; and, wherein:

FIG. 1 shows an advertisement insertion system 100 for dynamic interactive advertisement insertion into video content in accordance with an example;

FIG. 2 depicts the functionality of an AdFormat module operable to determine where to insert an advertisement into video content that is displayed to a viewer in accordance with an example;

FIG. 3 shows an animated pictorial of an advertising sequence.

FIG. 4 shows another animated pictorial of an advertising sequence.

FIG. 5 depicts the functionality of an AdFinder module operable to calculating a VAIA located within video content without compromising or interrupting a video scene action or motion in accordance with an example;

FIG. 6 depicts the functionality of an AdFinder module operable to calculate VAIA points located within video content without compromising action or motion of a video scene in accordance with an example;

FIG. 7 shows time lapsed frames of a video content where a collision may occur between the relevant and dominant object and an AD overlaid in a VAIA in accordance with an example;

FIG. 8 shows moving an advertisement (AD) from an original VAIA to a different VAIA to avoid the collision in accordance with an example;

FIG. 9 shows adjust the size of a VAIA to avoid a collision with a relevant and dominant object in accordance with an example;

FIG. 10 shows a VAIA passing through a relevant and dominant object in accordance with an example;

FIG. 11 shows an AD overlaid in a VAIA that remains in the boundaries a relevant and dominant object in accordance with an example;

FIG. 12 shows a VAIA is located within the boundaries of a relevant and dominant object that remains in the boundaries of the relevant and dominant object until the relevant and dominant object disappears from a video content in accordance with an example;

FIG. 13 shows an AD overlaid in a VAIA disappearing until the relevant and dominant object leaves a VAIA in accordance with an example;

FIG. 14 depicts the functionality of an AdInteractive Menu module operable to send an interactive menu configuration to a video player for an interactive menu inserted into a selected video content in accordance with an example;

FIG. 15 depicts a method to configure an interactive menu for a selected video content to the video player in accordance with an example;

FIG. 16 shows time lapsed frames of a video content with an interactive menu in accordance with an example;

FIG. 17 depicts the functionality of an AdForm module operable to configure a feedback form in accordance with an example;

FIG. 18 depicts the functionality of an AdForm module operable to display a graphical user interface to a viewer for the viewer interact with an advertisement in accordance with an example;

FIG. 19 shows an advertisement insertion system for dynamically inserting an advertisement into video content in accordance with an example;

FIG. 20 depicts a method for dynamically inserting an advertisement into video content at an advertisement insertion system in accordance with an example;

FIG. 21 depicts a method for calculating a VAIA within video content at an advertisement insertion system in accordance with an example;

FIG. 22 is block diagram illustrating an example of a computing device that may be used to execute a method for determining an item package quantity.

Reference will now be made to the exemplary embodiments illustrated, and specific language will be used herein to describe the same. It will nevertheless be understood that no limitation of the scope of the invention is thereby intended.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular examples only and is not intended to be limiting. The same reference numerals in different drawings represent the same element. Numbers provided in flow charts and processes are provided for clarity in illustrating steps and operations and do not necessarily indicate a particular order or sequence.

Viewers of web-based videos often desire to watch video content without disturbing advertisements or with minimal intrusion. The effectiveness of advertisements inserted in the video content can correlate with the placement or location of advertisements in the video content. Placement of advertisements in videos, such as web-based videos, has generally been in a fixed location, such as a banner on a top or bottom of a screen or a box in a corner of the screen. The fixed location of the advertisement space restricts the ability of an advertiser to display product features, provide additional information, or select advertisement insertion locations. Additionally, viewers have become accustomed to seeing advertisements in the fixed location and can become blind to the advertisements, e.g. automatically ignoring the advertisements. Fixed advertisement locations can decrease viewership of the advertisements and attentiveness of viewers to the advertisements. Decreased viewership and viewer attentiveness can diminish a success rate of an advertisement and revenues created by the advertisements.

Advertising that appears in conjunction with the video content, in order to be effective as well as maintain a satisfactory experience for the user takes into account the content and characteristics of the video in conjunction with the advertising content. Recently, major television networks have made available some of their programming on their websites. Web-based videos, such as movies or television shows, typically require a viewer to watch advertising content before, during or after the requested programming. A flexible advertising interface can provide users with requested video content and enable advertisers to promote products in a manner that is both satisfying to the viewer and effective for the advertisers.

As video content displayed to viewers varies, advertisers may desire to be able to customize an advertisement based on the displayed video content by changing advertisement parameters. The advertisement parameters can include a screen location of an advertisement window, a duration of time the advertisement is displayed, opacity/transparency level of the advertisement window, a volume level of the advertisement, an advertisement window size, a configuration of a pop-up menu, a sequence of the advertisement, alignment of the advertisement window relative to the video content, and so forth. The advertisement parameters can be selected based on the amount of attention that an advertiser desires a viewer to give the advertisement. In one embodiment, the advertisement parameters can be adjusted or changed in real-time or substantially real-time, e.g. while the video content is being displayed or streamed. One advantage of customizing the advertisement parameters in real-time can be to increase the impact of the advertisement on the viewers by increasing the integration of the advertisements with the video content.

In one embodiment, the advertisement parameters can be adjusted based on user input, such as from an advertiser. In another embodiment, the advertisement parameters can be adjusted based on determining a viable advertisement insertion area (VAIA). A VAIA is an area in video content for insertion of advertisements into the video content that will create an advertisement area size that does not interfere with relevant and dominant video scene and/or relevant and dominant objects in the video scene. In one embodiment, a relevant and dominant video scene or object can be one or more frames in the video content or objects in the video content that contain scenes or objects with an threshold amount of action and/or motion. For example, video content can include relevant and dominant objects or areas, such as a car driving in the scene, and non-dominant objects or areas, such as a background building, in the video content. In one embodiment, the VAIA can be determined by analyzing one or more frames of the video content to determine the dominant areas and the non-dominant areas. For example, the video content can be analyzed to determine non-dominant areas of the video content in a video window and advertising content can be displayed in the non-dominant areas of the video window.

In one embodiment, a relevant and dominant object can be an object in a video content scene with one or more selected dominant criteria, including: an object that exceeds a minimum threshold size; an object with movement in a video content scene that exceeds a minimum threshold movement value; an object with high detail compared to other object in a video content scene; an object with high resolution compared to other object in a video content scene; an object with selected features, such as an object that is a person; and so forth. In another embodiment, a non-dominant object can be an object in a video content scene with one or more selected non-dominant criteria, including: an object that is below a minimum threshold size, an object with movement in a video content scene that is below a minimum threshold movement value; an object with low detail compared to other object in a video content scene; an object with low resolution compared to other object in a video content scene; an object that is blurred and/or out of focus in a video content scene; and so forth. For example, a cloud in a sky or flooring in a building can be a low detail object in a video content scene.

In another example, the video content can be analyzed to determine dominant areas of the video content in a video window and advertising content can be displayed in locations other than the dominant areas of the video window. One advantage of displaying the advertisement content in non-dominant areas of the video window and/or locations other than the dominant areas of the video window can be to enable a viewer to watch the video content and at the same time view advertising content in non-obtrusive spots. In another embodiment, the VAIA can be determined based on one or more insertion areas rules. For example, the insertion areas rules can include: the distance between the VAIA and a dominant object, a size of the VAIA, a distance between a VAIA in a previous video content scene, a number of video content scenes a VAIA is available inside a dominant object, and so forth.

An advertisement insertion system can be used to dynamically insert content of an advertisement into video content, such as web-based video content. In another embodiment, the advertisement insertion system can be used to customize the content of an advertisement based on the video content the advertisement is inserted into. One advantage of dynamically inserting and/or customizing advertisement content can be to create an advertisement that is unique to the video content. Another advantage of dynamically inserting and/or customizing advertisement content can be to match the advertisement content with similar video content.

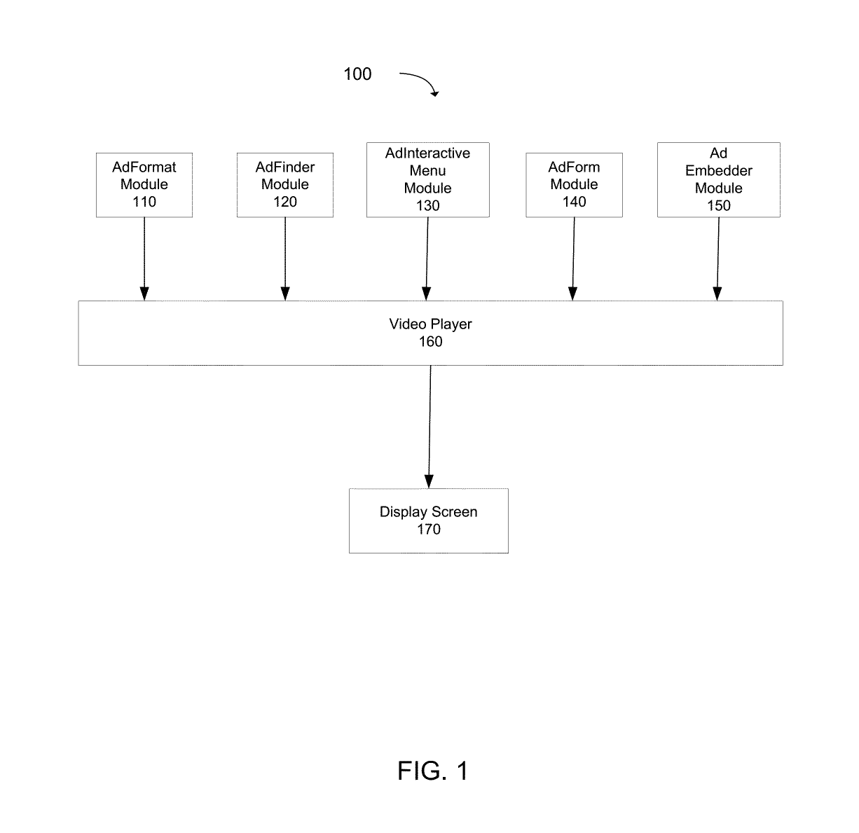

FIG. 1 shows an advertisement insertion system 100 for dynamic interactive advertisement insertion into video content. In one embodiment, the advertisement insertion system 100 can include a video player 160, such as a web-based video player, to show video content in a video window of a display screen 170. In one embodiment, the video content can contain non-obtrusive advertisements embedded is video content. The video player 160 can receive advertisement insertion information and/or customization information from several modules including: an AdFormat module 110, an AdFinder module 120, an AdInteractive Menu module 130, an AdForm module 140, and an AdEmbedder module 150. The advertisement insertion system 100 can enable an advertiser to dynamically insert advertisements into non-obtrusive and/or non-dominant areas of a video content. One advantage of dynamically inserting advertisements into video content can be to enable a viewer of watch the video content and enable advertisers to insert advertisements adapted to the video content. Advertisements adapted to the video content can reduce or eliminate obstructing the video content while displaying the advertisements. In one embodiment, the advertisements can be adapted in real-time or substantially real-time for the displayed video content.

In one embodiment, the advertisements can be formatted as video content, web 3D objects, static images, animated images, and so forth. In another embodiment, the advertisement insertion system 100 can format the video content that includes the inserted advertisements for displaying of the video content on a display screen 170. In one embodiment, the display screen 170 can be the display screen of a smartphone, a tablet, a laptop, a desktop computer display, a television, or other display screens.

In one embodiment, the advertisement insertion system 100 can dynamically insert advertisements into video content automatically at VAIAs based on advertiser preferences. In one embodiment, the AdFormat module 110 can send the video player 160 one or more advertisements. In another embodiment, the advertisements can be linearly formatted advertisements and/or non-linear formatted advertisements. In one embodiment, a linear advertisement can be separate from the video content, e.g. the linear advertisement can be inserted before the video content, after the video content, and/or in the middle of paused video content. In another embodiment, a non-linear advertisement can be integrated into the video content.

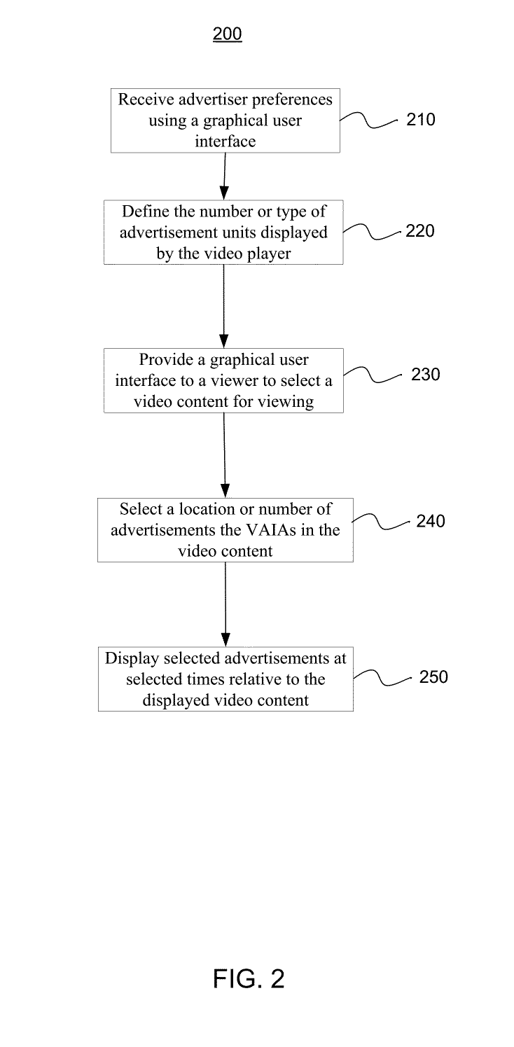

FIG. 2 provides a flow chart 200 to illustrate the functionality of one embodiment of an AdFormat module of the advertisement insertion system, as shown in FIG. 1, that is operable to determine where and/or when to insert an advertisement into video content that is displayed to a viewer. The functionality may be implemented as instructions on a medium or one non-transitory machine readable storage medium. The AdFormat module can be configured to receive advertiser preferences using a graphical user interface, as shown in block 210. In one embodiment, the graphical user interface can be a web-based user interface to enable an advertiser to create an advertising format composed of linear advertisement sequences and/or non-linear advertisements sequences. In another embodiment, the advertiser preferences can include the time when the advertisement is displayed relative to the video content. For example, the advertisement sequences can be displayed in a pre-roll format, a split screen format, a mid-roll format, and/or a post roll format. In another embodiment, non-linear advertisements sequences can be inserted within linear advertisement sequences.

In one embodiment, the AdFormat module can associate or customize the alignment of selected advertisements with advertisement VAIAs. In another embodiment, the AdFormat module can associate or customize the alignment of selected advertisements in an advertisement sequence to provide a viewer a coherent or uninterrupted story. For example, the AdFormat module can insert a pre-roll advertisement that contains a teaser asking for the viewers to interact with the advertisement. In one example, the pre-roll advertisement teaser can be a Coca-Cola™ cap inserted into a VAIA. When the pre-roll advertisement concludes, the advertisement can be followed by video content containing several advertisements overlaid in VAIAs, and after the video content has concluded, a post-roll advertisement can display a feedback incentive, further discussed in the proceeding paragraphs, based on one or more interactions of the viewer with the pre-roll advertisements and/or the integrated advertisements.

The AdFormat module can be further configured to define the number and/or type of advertisement units displayed by the video player, as shown in block 220. In one embodiment, the AdFormat module can be configured to provide a graphical user interface for a viewer to select a video content for viewing, as shown in block 230. In another embodiment, the AdFormat module can be configured to select a location and/or a number of advertisements overlaid in the VAIAs of the video content, as shown in block 240. In another embodiment, the AdFormat module can be configured to display selected advertisements at selected times relative to the displayed video content, as shown in block 250.

In one example, an advertisement sequence can include a pre-roll advertisement video, followed by a plurality of advertisements overlaid in VAIAs contained in the selected video content, and a post-roll advertisement video. In another example, an advertisement sequence can include a pre-roll advertisement video with advertisements overlaid in VAIAs, followed by advertisements overlaid in the VAIAs contained in the selected video content, and a post-roll advertisement video with advertisements overlaid in the VAIAs. In another embodiment, the advertisement sequences overlaid in the VAIAs can be displayed adjacent or near the center of the display, as limited by VAIA policies.

In one embodiment, the AdFormat module can receive configuration information. The configuration information can include sequence format information of the advertisement, such as whether an advertisement is a linear advertisement or a non-linear advertisement. In one embodiment, the AdFormat module can determine when to display the advertisement relative to the video content being displayed to the viewer. For example, the AdFormat module can configure the advertisement to be displayed: before the video content is displayed, i.e. a pre-roll advertisement; simultaneous while the video content is displayed, i.e. a split screen advertisement or a mid-roll advertisement; and/or after the video content is displayed, i.e. a post roll advertisement.

In another embodiment, the AdFormat module can associate and/or customize the alignment of an advertisement with a VAIA. In one example, the AdFormat module can associate and/or customize an advertisement to provide a sequence of advertisements that provides a viewer with video content that includes advertisements and conveys a fluid and coherent story to the viewer.

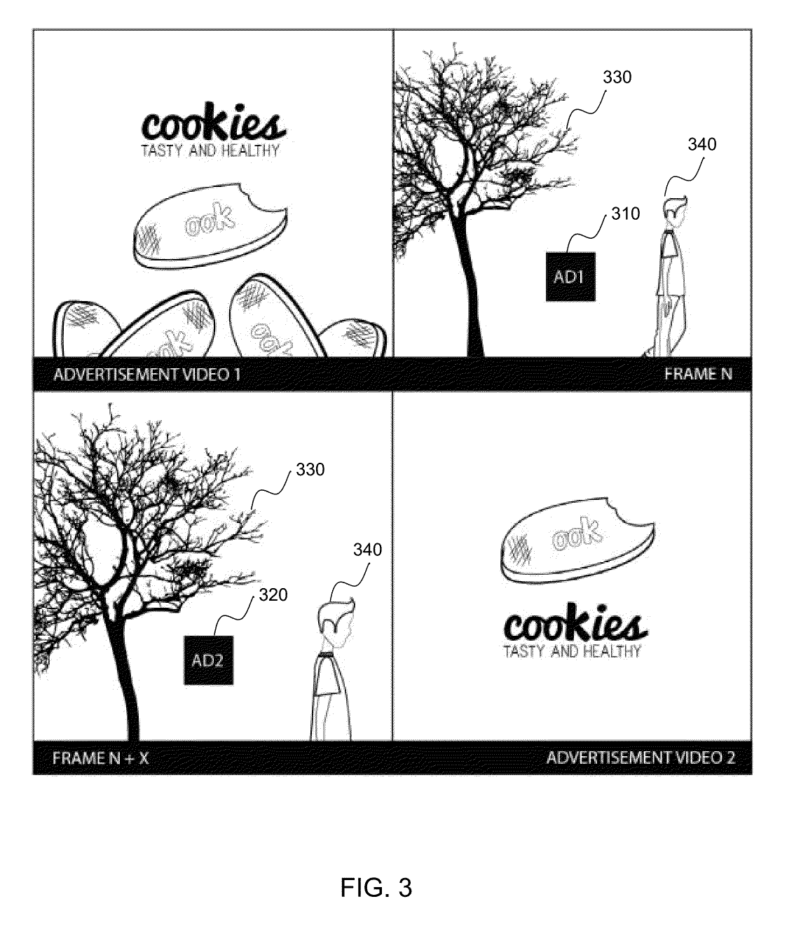

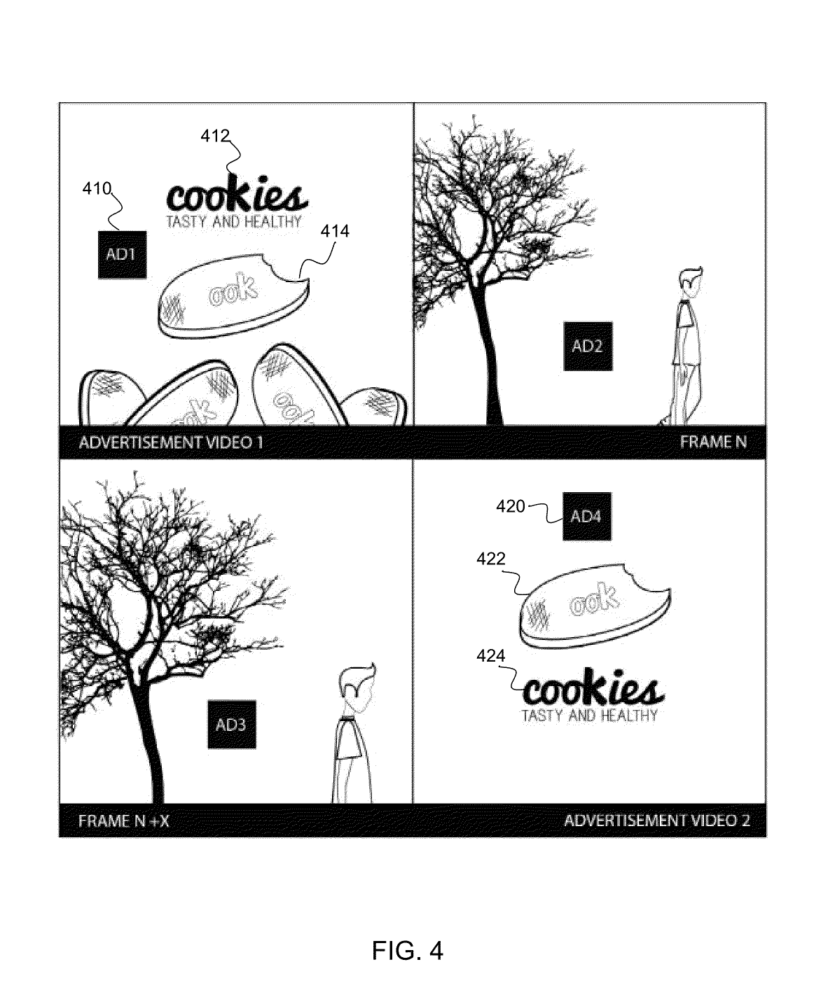

FIGS. 3 and 4 show advertisement sequences that include advertisements inserted by the advertisement insertion system into advertisement videos. FIG. 3 shows an animated pictorial of an advertising sequence. A first pictorial block Advertisement Video 1 shows a pre-roll advertisement video. Pictorial blocks Frame N and Frame N+X show two consecutive time lapsed frames of video content containing advertisements AD1 and AD2 overlaid in selected VAIAs 310 and 320. In another embodiment, pictorial blocks Frame N and Frame N+X are nonconsecutive frames of a video content. FIG. 3 further shows that the AD1 and AD2 can be inserted within the pictorial blocks Frame N and Frame N+X at locations that can avoid or minimize obstructing relevant and dominant objects 330 and 340. Pictorial block Advertisement Video 2 shows a post-roll advertisement video.

FIG. 4 shows another animated pictorial of an advertising sequence. A first pictorial block Advertisement Video 1 shows a pre-roll advertisement video containing AD1 overlaid in a selected VAIA 410. The AD1 can be inserted at a location within the Advertisement Video 1 that avoids or minimizes obstructing relevant and dominant objects 412 and 414. Pictorial blocks Frame N and Frame N+X are the same as the pictorial blocks Frame N and Frame N+X in FIG. 3. Pictorial block Advertisement Video 2 shows a post-roll advertisement video containing AD4 overlaid in a selected VAIA 420. The AD4 can be inserted at a location within the pictorial block Advertisement Video 2 that avoids or minimizes obstructing relevant and dominant objects 422 and 424. In one embodiment, the insertion of advertisements in the VAIAs within the advertisement videos, such as pre-rolls, mid-rolls, or post-rolls, can provide interactive videos without changing the characteristics and/or format of the advertisement videos. One advantage of inserting AD1, AD2, AD3, and AD4 in FIGS. 3 and 4 at the VAIAs can be to enable advertisers to dynamically add additional advertisements and/or advertisement information while substantially preserving the video content and providing a viewer a coherent story line. In one embodiment, the advertisements AD1, AD2, AD3 and AD4 in FIGS. 3 and 4 can each be the same advertisement. In one embodiment, the advertisements AD1, AD2, AD3 and AD4 in FIGS. 3 and 4 can each be different advertisements.

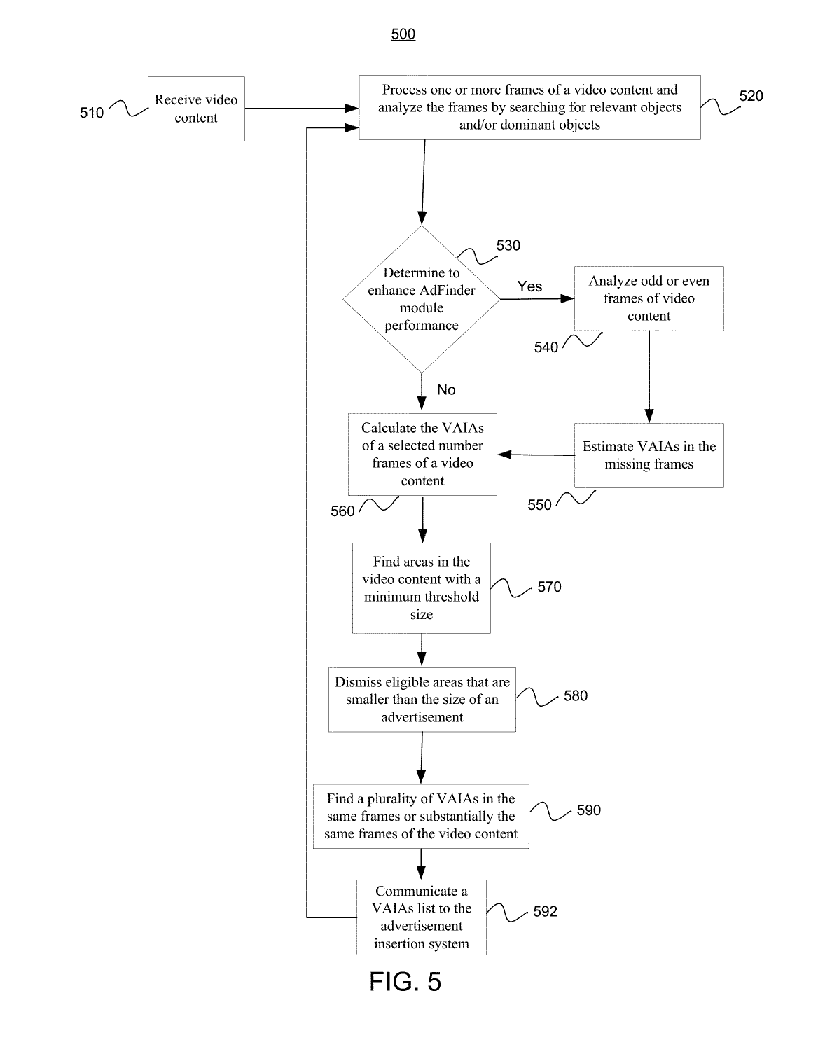

FIG. 5 provides a flow chart 500 to illustrate the functionality of one embodiment of an AdFinder module of the advertisement insertion system, as shown in FIG. 1, that is operable to calculating a VAIA located within video content without compromising or interrupting a video scene action or motion. The functionality may be implemented as instructions on a machine, where the instructions are included on at least one computer readable medium or one non-transitory machine readable storage medium. In one embodiment, the AdFinder module can be configured to receive video content, as shown in block 510. In another embodiment, the AdFinder module can be further configured to process one or more frames of a video content and analyze the frames by searching for relevant objects and/or dominant objects, as shown in block 520. In another embodiment, the AdFinder module can be further configured to determine to enhance the performance of the AdFinder module, as shown in block 530.

In another embodiment, when the performance of the AdFinder module is enhanced, the AdFinder module can be configured to analyze odd frames or even frames of video content, as shown in block 540. Additionally, when the performance of the AdFinder module is enhanced, the AdFinder module can be configured to estimate the VAIAs in the missing frames, e.g. the even frames or odd frames respectively, as shown in block 550. In one embodiment, the AdFinder module can be configured to calculate the VAIAs of a selected number of frames in a video content, as shown in block 560. In one embodiment, when the performance of the AdFinder module is enhanced, the AdFinder module can calculate the VIAAs for only the odd or even analyzed frames.

In one embodiment, the AdFinder module can be configured to analyze the frames and search for relevant objects and/or dominant objects. In one embodiment, the AdFinder module can automatically analyze the frames and determine when an object is a dominant object or a non-dominant object. In another embodiment, the AdFinder module can be configured to analyze the frames irrespective of any color or background pattern in the frames. In another embodiment, the AdFinder module can be configured to find areas (such as circular areas, quadrangular areas, and/or rectangular areas) in the video content eligible for having an advertisement with a minimum threshold size inserted into the video content without interfering or colliding with a relevant and dominant object in the video content, as shown in block 570. In one embodiment, the AdFinder module can be configured to find eligible areas in the video content by finding viable areas in the video content that remain unchanged or substantially unchanged for a threshold period of time and/or a minimum number of consecutive frames. In one embodiment, the AdFinder module can be configured to analyze video content to determine locations of VAIAs and/or times of VAIAs in the video content.

In another embodiment, the AdFinder module can be configured to dismiss eligible areas that are smaller than the size of an advertisement selected to be inserted in the video content, as shown in block 580. In another embodiment, the AdFinder module can be configured to find a plurality of VAIAs in the same frames or substantially the same frames of the video content, as shown in block 590. In one embodiment, when video content contains multiple VAIAs for the same frames, the AdFinder module can be configured to prioritize or categorize the VAIAs based on advertiser preferences. In another embodiment, the AdFinder module can be configured to communicate a VAIAs list to the advertisement insertion system, as shown in block 592. In one embodiment, the VAIAs list can include a list of all eligible VAIAs in the video content. In another embodiment, the VAIAs list can include advertisement placement information to indicate where the locations of the VAIAs are in one or more frames. In another embodiment, the VAIAs list can include a number of VAIAs simultaneously eligible for the selected advertisements. In another embodiment, the VAIAs list can be filtered based on advertiser preferences and/or viewer preferences.

In one embodiment, the advertiser preferences can be used to automatically adjust one or more advertisements. For example, the advertiser preferences can be used to adjust the advertisements for VAIAs in selected video content to increase viewing time of the advertisements by a viewer; adjust a size of the advertisements for selected VAIAs; adjust a number of simultaneously visible VAIAs; adjust a location of the advertisement relative to a center of the video window; adjust the location of the advertisement relative to one or more corners of the video window; adjust the advertisement to fit the largest VAIA available; adjust a location of the advertisement relative to the action of the video content; adjust a location of the advertisement to increase a period of time the VAIA is available to display the advertisement; and so forth. In one embodiment, the advertisement insertion system can prioritize available VAIAs. For example, the advertisement insertion system can give the highest priority to VAIAs located within relevant objects and/or dominant objects.

In one embodiment, the AdFinder module can be configured to determine a VAIA based on a display threshold value. The display threshold value can be a threshold value of a selected period of time that a VAIA exists for a consecutive number of frames in the video content. In one embodiment, the AdFinder module can be configured to use a graphical user interface to receive advertisement (AD) preference information. The graphical user interface can be configured to receive user input for AD preferences including: a minimum AD exposure time threshold, minimum and/or maximum threshold values for AD window sizes, and a list of advertisement placement criteria in order to establish a preferences list containing criteria to apply in the VAIAs. In one embodiment, the graphical user interface can receive default AD preference information, such as a default advertisement content location in the video window (such as in the center of the video window or at a corner of the video window), a minimum or maximum viewing area, an advertisement placement location relative to a relevant and dominant video object, and/or a minimum AD display time period duration.

In one embodiment, the AdFinder module can be configured to indicate to a user a number of VAIAs in the video content. In another embodiment, a user can select one or more VAIAs in the video content to display an advertisement. In another embodiment, the AdFinder module can be configured to automatically determine one or more of the AD preferences to adjust an advertisement for a specific video content to increase the number of views of an advertisement and/or adjust the size of the VAIA to maximize the area the advertisement is displayed in the video content window.

In one embodiment, a plurality of advertisements can be displayed at the same time at different location in a video window. In one embodiment, the graphical user interface can receive AD preference information for a maximum number of advertisements that can be displayed simultaneously at different VAIAs.

In one embodiment, the AdFinder module can be configured to determine relevant and dominant video scenes and/or possible collisions of an advertisement with relevant and dominant video scenes by analyzing the video content frames for motion, action, and/or relevant and dominant objects. In one embodiment, the AdFinder module can be configured to analyze frames of the video content one by one, e.g. frame by frame. In another embodiment, the AdFinder module can be configured to divide the video content into video content subsets and analyze the video content subsets.

The AdFinder module can be configured to analyze the video content to determine each frame of the video content that contains one or more circular, quadrangular, and/or rectangular VAIAs with selected frame criteria that are available to insert advertisements. In one embodiment, the selected frame criteria can include a minimum area size in the video content that remains unchanged or substantially unchanged for a selected number of consecutive frames. One advantage of the AdFinder module being configured to analyze each frame of video content for VAIAs can be to enable the advertisement insertion system to adapt the insertion of advertisements to different video content.

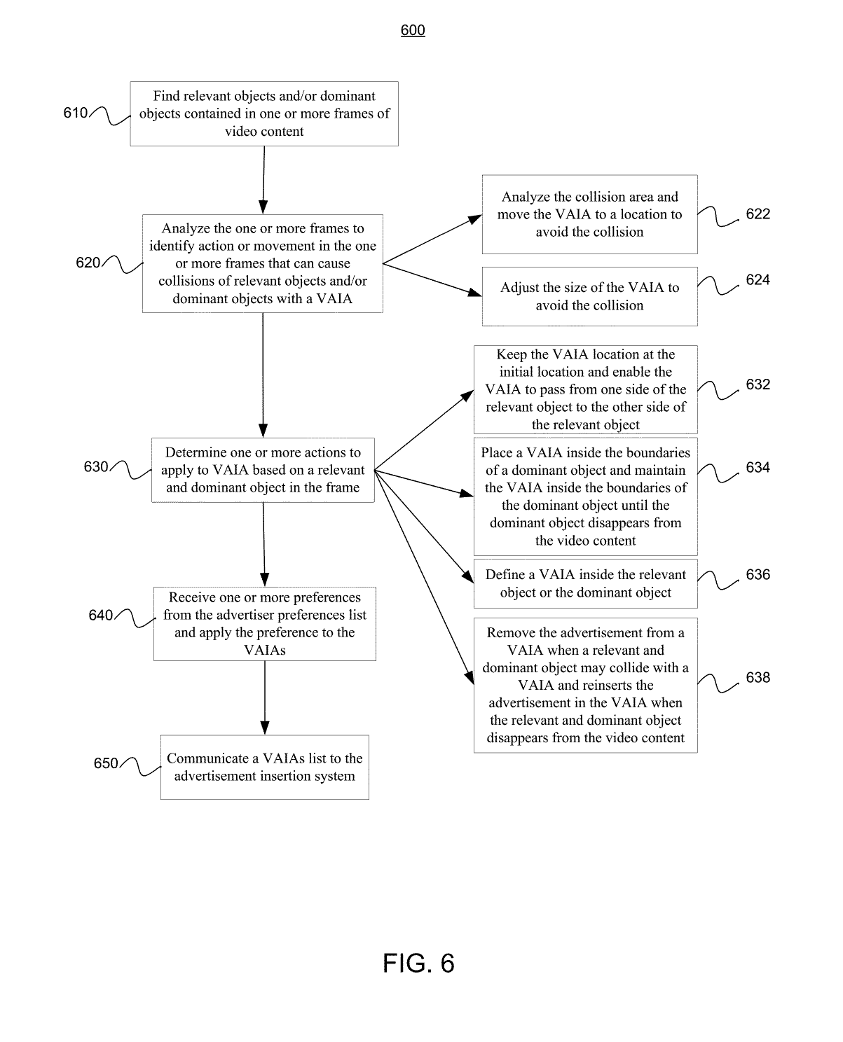

FIG. 6 provides a flow chart 600 to illustrate the functionality of another embodiment of an AdFinder module of the advertisement insertion system, as shown in FIG. 1, that is operable to calculate VAIA points located within video content without compromising action or motion of a video scene. The functionality may be implemented as instructions on a machine, where the instructions are included on at least one computer readable medium or one non-transitory machine readable storage medium. The AdFinder module can be configured to find relevant objects and/or dominant objects contained in one or more frames of video content, as shown in block 610. The AdFinder module can further be configured to analyze the one or more frames to identify action or movement in the one or more frames that can cause collisions of relevant objects and/or dominant objects with a VAIA, as shown in block 620. In one embodiment, when a frame with a pending collision of a relevant and dominant object with a VAIA is identified, the AdFinder module can be configured to analyze the collision area and move the VAIA to a location to avoid the collision, as shown in block 622. In one embodiment, when the relevant and dominant object has passed the collision area, the advertisement can return to the initial VAIA location. In one embodiment, the AdFinder module can be configured to move the VAIA to an area closest to the initial VAIA location while avoiding a collision with the relevant object and/or dominant object. In one embodiment, a current VAIA can overlap with a previous VAIA. In another embodiment, when several areas close to the initial VAIA location are available to move the advertisement to in order to avoid a collision, the VAIA can be moved to a location with the largest area available to display the advertisement. In one embodiment, when a frame with collision of a relevant and dominant object with a VAIA is identified, the AdFinder module can be configured to adjust the size of the VAIA to avoid the collision, as shown in block 624. In one embodiment, when a pending collision is detected, the AdFinder module can shrink the VAIA to avoid the collision and when the relevant and dominant object has passed the collision area, the AdFinder module can resize the VAIA to the initial size of the VAIA.

In one embodiment, when the location and/or size of the VAIA can not be adjusted to avoid a collision with a relevant and dominant object in a frame, the AdFinder module can be configured to determine one or more actions to apply to VAIA based on a relevant and dominant object in the frame, as shown in block 630. In one embodiment, the AdFinder module can be configured to keep the VAIA location at the initial location and enable the VAIA to pass from one side of the relevant object and/or dominant object, through the relevant object and/or dominant object, and to the opposite side of the relevant object and/or dominant object, as shown in block 632. In another embodiment, the AdFinder module can be configured to place a VAIA inside the boundaries of a relevant and dominant object and maintain the VAIA inside the boundaries of the relevant and dominant object until the relevant and dominant object disappears from the video content, as shown in block 634. In one embodiment, when the relevant and dominant object disappears from the video content, the advertisement can remain at a selected VAIA. In another embodiment, when a relevant and dominant object is in one or more frames of the video content, the AdFinder module can be configured to define a VAIA inside the relevant object or the dominant object, as shown in block 636. In another embodiment, the AdFinder module can remove the advertisement from a VAIA when a relevant and dominant object may collide with a VAIA and reinserts the advertisement in the VAIA when the relevant and dominant object disappears from the video content, as shown in block 638.

In another embodiment, the AdFinder module can be configured to receive one or more preferences from an advertiser preferences list and apply the advertiser preferences to the VAIAs, as shown in block 640. In one embodiment, the preferences of the advertiser preferences list can include: a size of the advertisement, an exposure of the advertisement, and a number of simultaneous VAIAs in the same frames of video content. In another embodiment, the AdFinder module can be configured to communicate a VAIAs list to the advertisement insertion system, as shown in block 650. In one embodiment, the VAIAs list can include a list of all eligible VAIAs in the video content. In another embodiment, the VAIAs list can include advertisement placement information to indicate where the locations of the VAIAs are for one or more frames of the video content. In another embodiment, the VAIAs list can include a number of VAIAs simultaneously eligible for the selected advertisements. In another embodiment, the VAIAs list can be filtered based on the advertiser preferences and/or viewer preferences.

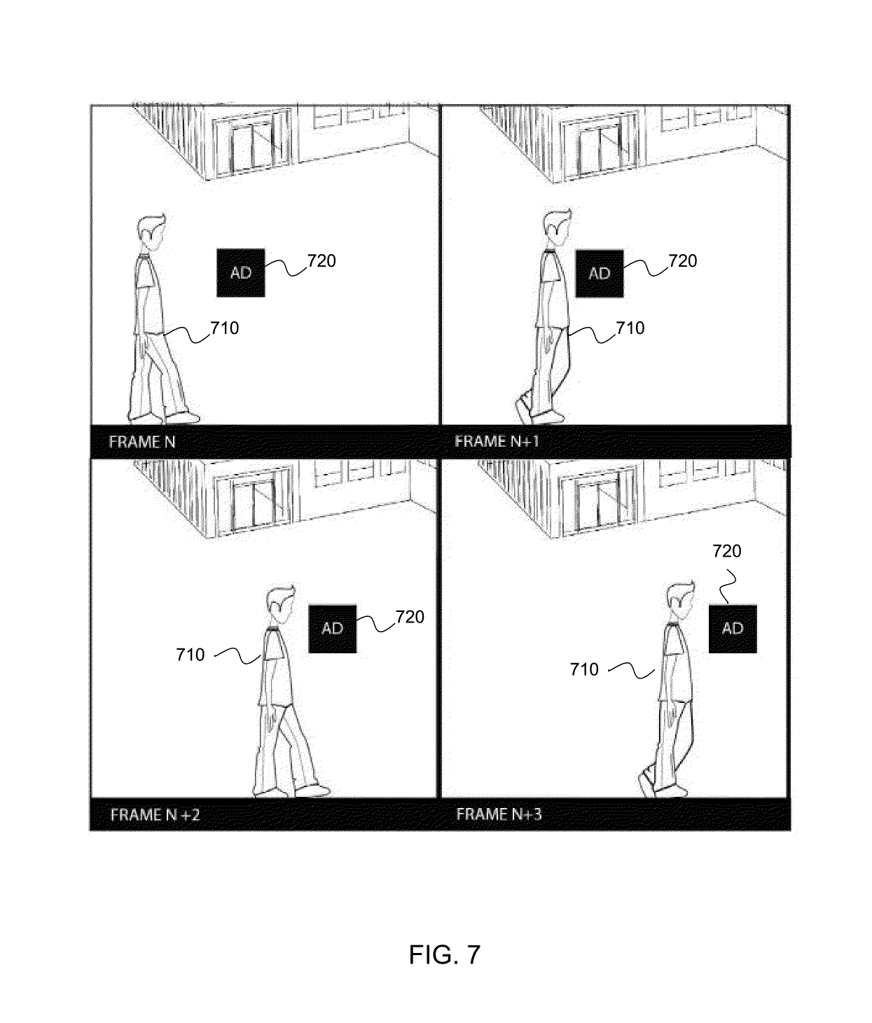

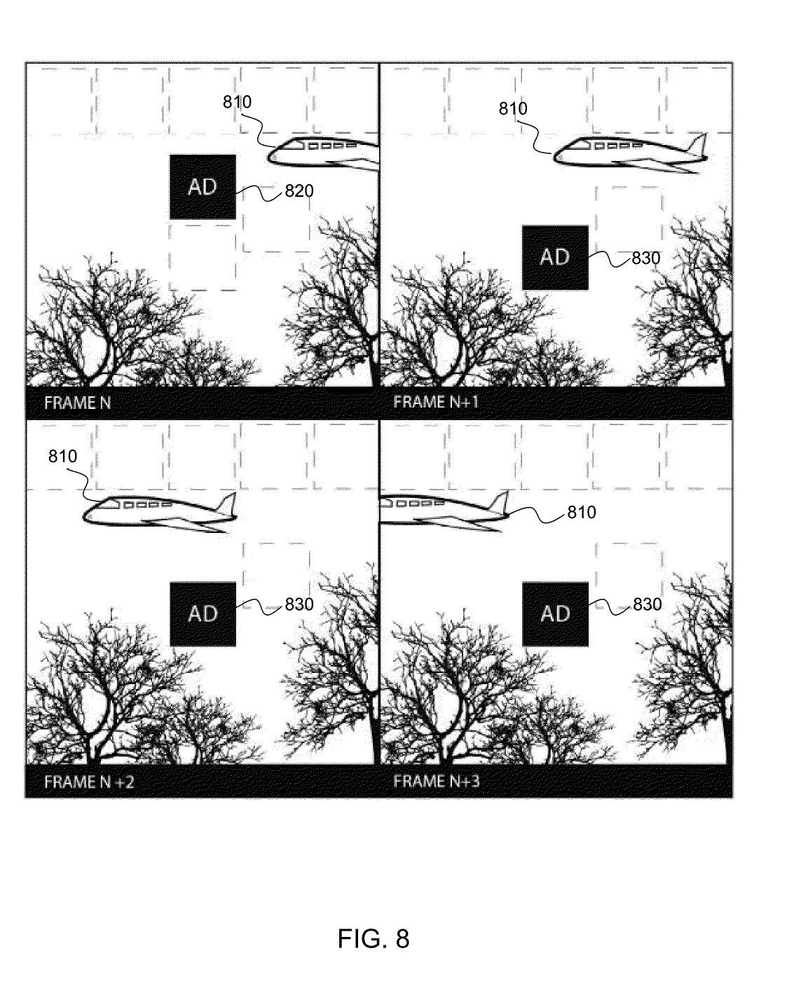

FIGS. 7 and 8 shows animated pictorials of an advertising sequence implementation with a plurality of frames where an advertisement (AD) moves locations to avoid a collision with a relevant object and/or dominant object, as discussed preceding paragraphs for step 622 in FIG. 6. FIG. 7 shows time lapsed Frames N, N−1, N+2, and N+3 of a video content where a collision may occur between the relevant and dominant object 710 and an AD overlaid in a VAIA 720. When the AdFinder module determines that a collision will occur, the AdFinder module can move the VAIA 720 of the AD to avoiding the collision. FIG. 7 shows the AD overlaid in the VAIA 720, wherein when the AdFinder module determines a pending collision between the VAIA 720 and the relevant and dominant object 710, e.g. the a man walking, will occur, the AdFinder module can move with the VAIA 720 from the original VAIA position to another VAIA position to avoid a collision with the relevant and dominant object 710.

FIG. 8 shows time lapsed Frames N, N+1, N+2, and N+3 of a video content where a collision may occur between the relevant and dominant object 810 and an AD overlaid in a VAIA 820, as discussed preceding paragraphs for step 622 in FIG. 6. FIG. 8 further shows that when the AdFinder module determines that a collision will occur between a relevant and dominant object 810, e.g. the airplane, and an AD overlaid in a VAIA 820 in Frame N, the AdFinder module can move the AD from the original VAIA to a different VAIA to avoid the collision. For example, when the AdFinder module determines that a collision will occur, the AdFinder module can move the AD to another VAIA 830 in Frame N−1. In one embodiment, when a plurality of adjacent eligible VAIAs are available, the AdFinder Module can select an eligible VAIA with the largest area available. In one embodiment, one VAIA can overlap another VAIA. In one embodiment, when the relevant and dominant object 810 has passed a collision area in Frame N+4, the AD can remain at the other VAIA 830.

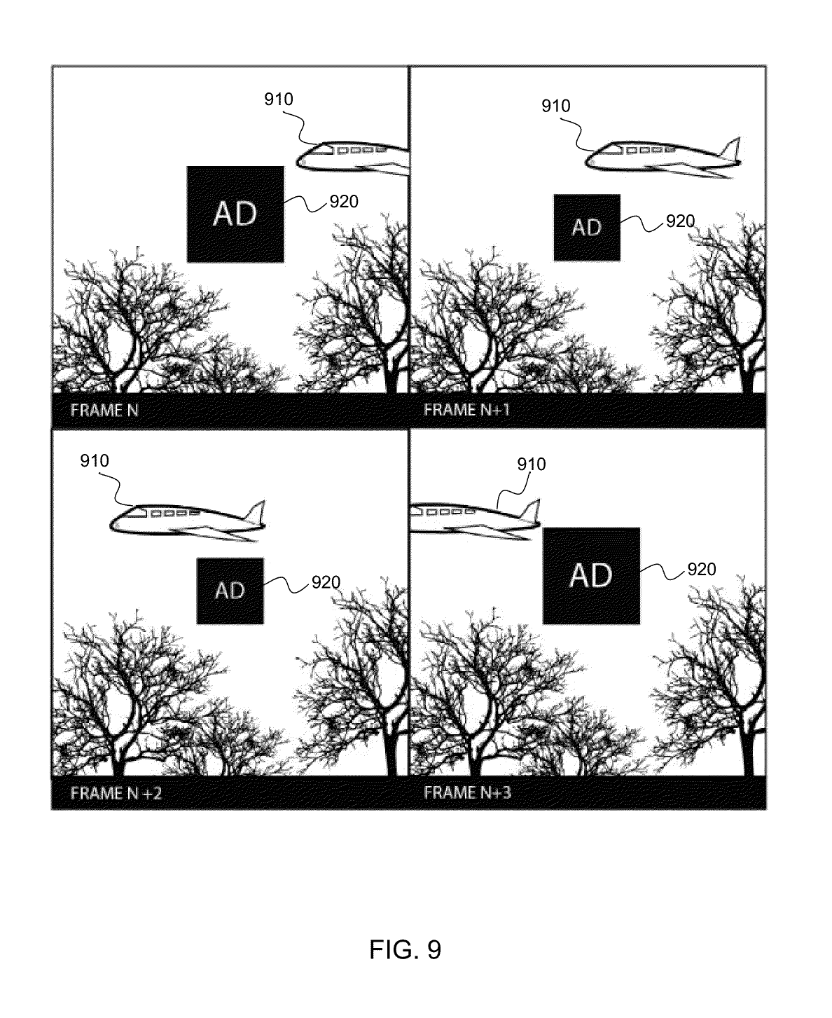

FIG. 9 shows time lapsed Frames N, N−1, N+2, and N+3 of a video content where a collision may occur between the relevant and dominant object 910 and an AD overlaid in a VAIA 920. FIG. 9 further shows that when collision of a relevant and dominant object 910 with an AD overlaid in a VAIA 920 in Frame N, the AdFinder module can adjust the size of the VAIA 920 to avoid the collision in Frames N+1 and N+2, as discussed preceding paragraphs for step 624 in FIG. 6. In one embodiment, the AdFinder module can adjust the size of the VAIA 920 to a minimum threshold size during the Frames N−1 and N+2 where a collision will occur and then expand the VAIA 920 to the initial size of the VAIA in Frame N after the relevant and dominant object 910 has passed through the frames of the video content. In another embodiment, the AdFinder module can adjust the VAIA 920 to a maximum size possible while avoiding a collision with the relevant and dominant object 920.

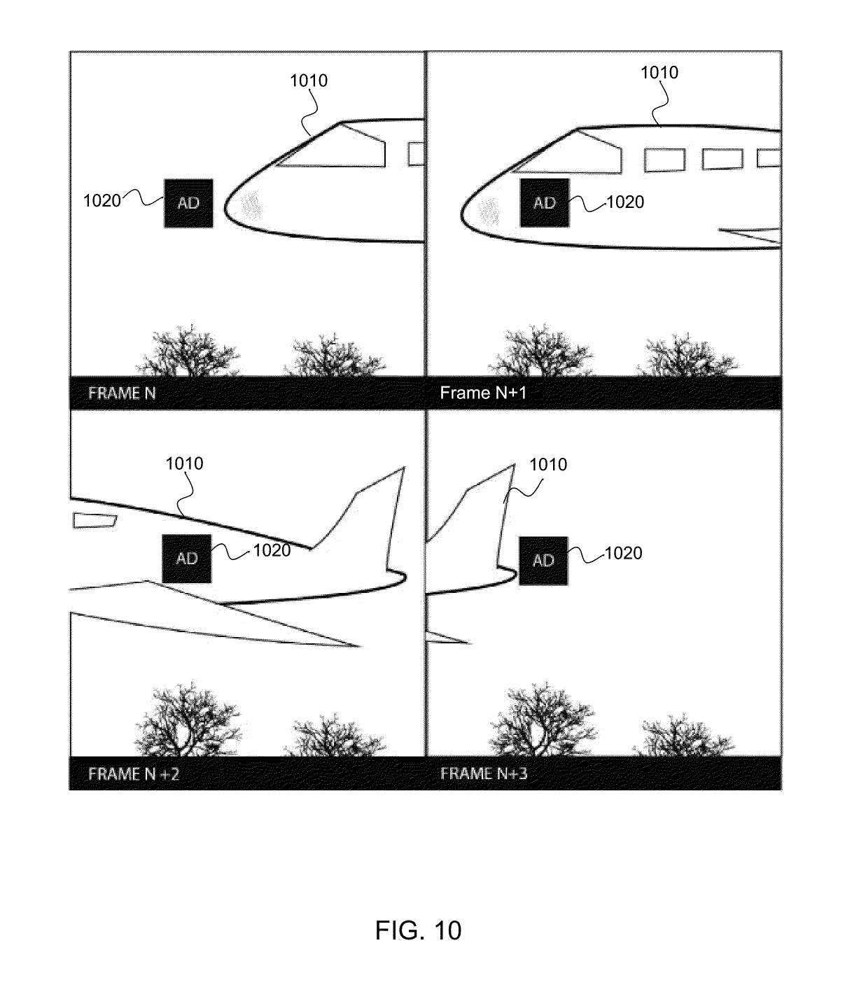

FIG. 10 shows time lapsed Frames N, N−1, N+2, and N+3 of a video content where a collision may occur between the relevant and dominant object 1010 and an AD overlaid in a VAIA 1020. FIG. 10 further shows a VAIA 1010 passing from one side of the relevant and dominant object 1010, through the relevant and dominant object 1010, to the other side of the relevant and dominant object 1010, as discussed preceding paragraphs for step 634 in FIG. 6. In one embodiment, the VAIA 1020 can pass through the relevant and dominant object 1010 when the size of the VAIA 1020 cannot be adjusted to avoid a collision and no other eligible VAIAs are available. In one embodiment, the AD in the VAIA 1020 can be centered relative to one or more boundaries of the relevant and dominant object 1010. In FIG. 10, the relevant and dominant object 1010, e.g. the airplane, collides with the AD inserted in the VAIA 1010 in Frames N−1 and N+2. In one embodiment, the AD inserted in the VAIA 1010 can remain in the same location after the relevant and dominant object 1010 has passed, as shown in Frame N+3.

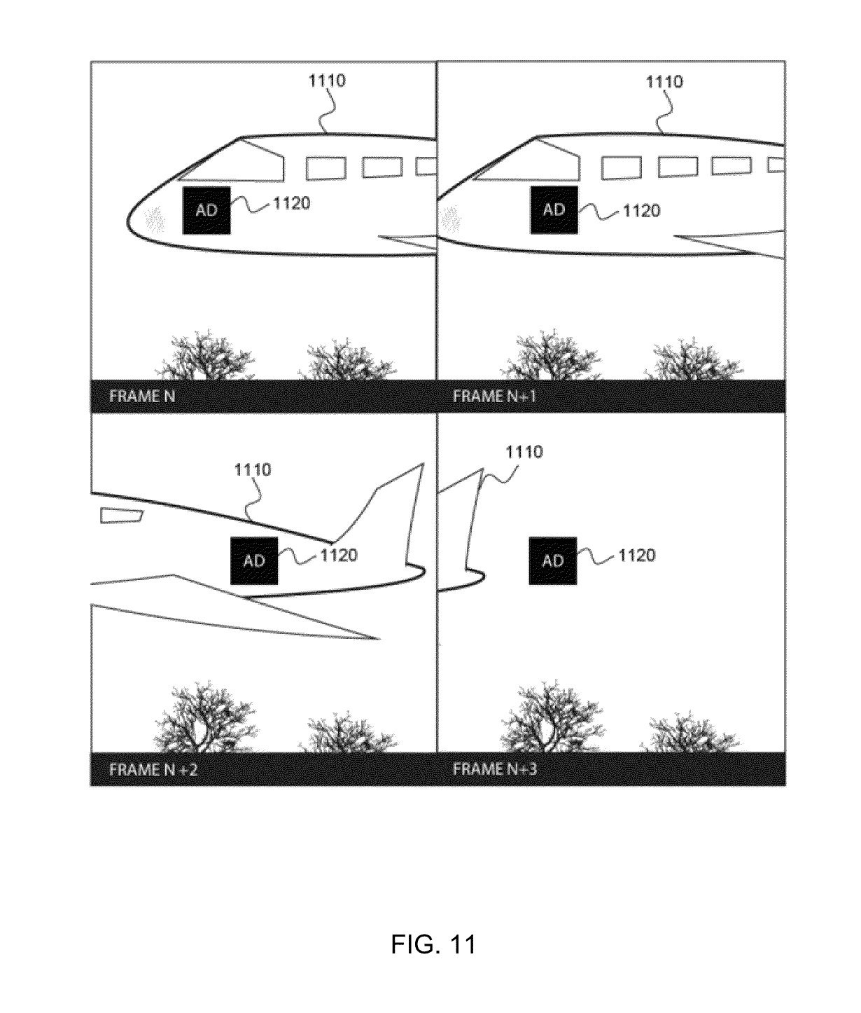

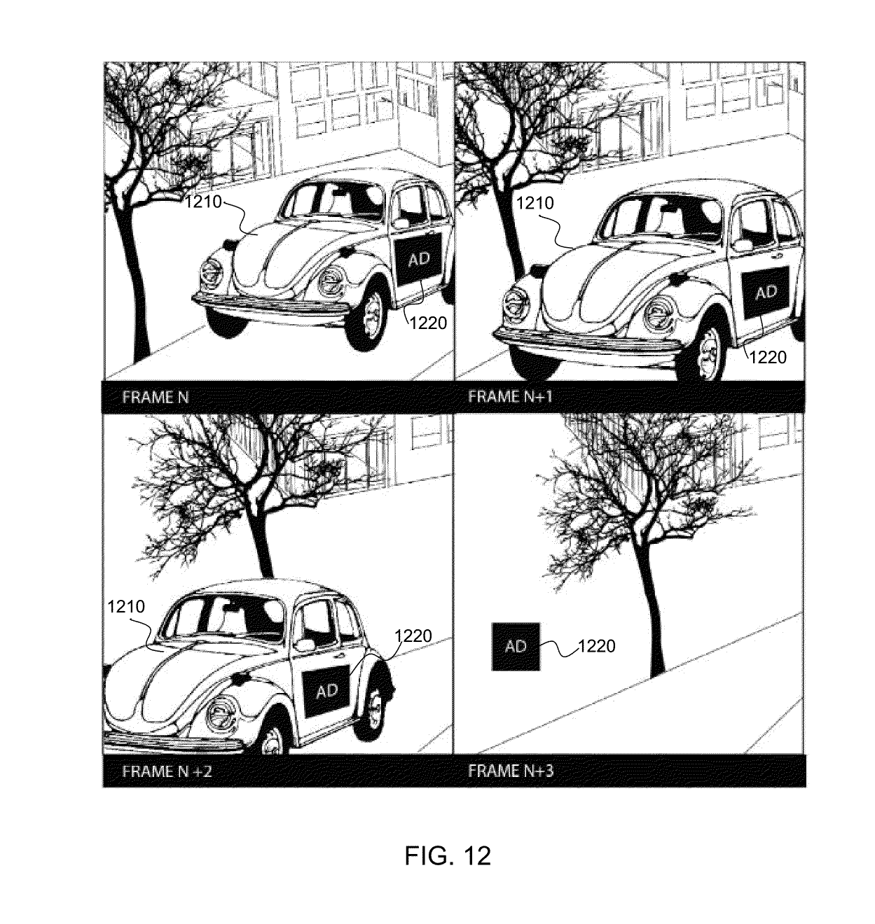

FIGS. 11 and 12 shows animated pictorials of time lapsed Frames N, N−1, N+2, N+3 of video content wherein a VAIA 1120 is located within the boundaries of a relevant and dominant object and remains in the boundaries of a relevant and dominant object until the object disappears from the video content. FIG. 11 shows Frames N, N−1, and N+2 with an AD overlaid in a VAIA 1120 that remains in the boundaries a relevant and dominant object 1110, e.g. an airplane, until the relevant and dominant object 1110 passes through the video content, as shown in Frame N+3, as discussed preceding paragraphs for step 636 in FIG. 6. In one embodiment, the AD overlaid in a VAIA 1120 can remain in the same location after the relevant and dominant object 1110 passes through the video content, as shown in Frame N+3.

FIG. 12 shows another animated pictorials of time lapsed Frames N, N+1, N+2, N+3 of video content wherein a VAIA 1220 is located within the boundaries of a relevant and dominant object 1210 and remains in the boundaries of the relevant and dominant object 1210 until the relevant and dominant object 1210 disappears from the video content, as discussed preceding paragraphs for step 636 in FIG. 6. In FIG. 12, an AD overlaid in a VAIA 1220 is inserted within the relevant and dominant object 1210 (e.g. the car), as shown in Frames N, N−1, and N+2. The AD overlaid in the VAIA 1220 remains within boundaries of the relevant and dominant object 1210 until the relevant and dominant object 1210 disappears from the video content, as shown in Frame N+3. In one embodiment, ADs overlaid in VAIAs can be adapted to a perspective, plane, rotation, and/or proportion of the VAIAs to provide seamlessly embedding of the ADs into video content and enhance the viewing experience of a viewer.

In one embodiment, a plurality of VAIAs can be simultaneously available to insert ADs. In one example, an AD can be inserted into a plurality of different VAIAs. In another example, a plurality of different ADs can be inserted into different VAIAs. One advantage of inserting different ADs into different VAIAs can be to provide a viewer the impression of a sequence in a story and/or a coherent story being told. In one embodiment, the ADs inserted in the VAIAs cannot be canceled or removed by a video player.

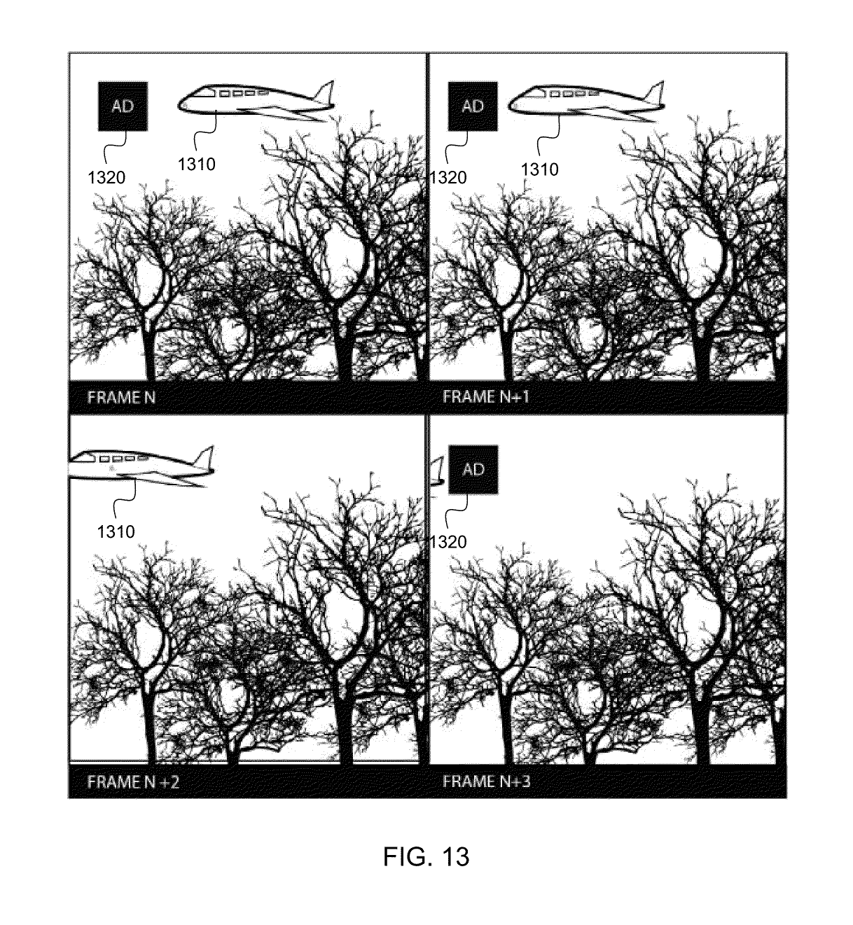

FIG. 13 shows time lapsed Frames N, N−1, N+2, and N+3 of a video content where a collision may occur between the relevant and dominant object 1310 and an AD overlaid in a VAIA 1320. FIG. 13 further shows a collision may occur between the relevant and dominant object 1310, e.g. the airplane, and an AD overlaid in a VAIA 1320 where no other VAIAs are available, as shown in Frames N and N+1, as discussed preceding paragraphs for step 638 in FIG. 6. When a collision may occur between the relevant and dominant object 1310 and the AD overlaid in the VAIA 1320 and no other VAIAs are available, the AD overlaid in a VAIA 1320 can disappear until the relevant and dominant object 1310 leaves the VAIA 1320, as shown in Frame N+3. In one embodiment, when the relevant and dominant object 1310 leaves the location of the VAIA 1320, the AD returns to the original VAIA 1320, as shown in Frame N+3.

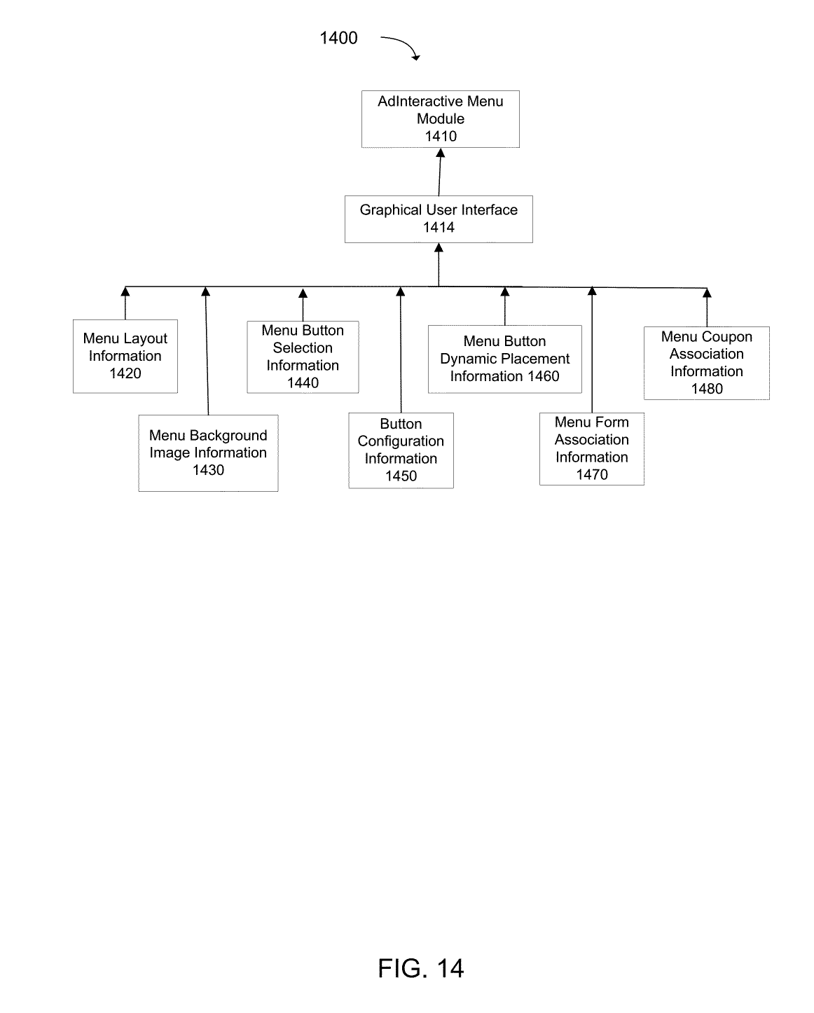

FIG. 14 provides a flow chart 1400 to illustrate the functionality of one embodiment of an AdInteractive Menu module 1410 of the advertisement insertion system, as shown in FIG. 1, that is operable to send an interactive menu configuration, to a video player, for an interactive menu inserted into a selected video content. The functionality may be implemented as instructions on a machine, where the instructions are included on at least one computer readable medium or one non-transitory machine readable storage medium. In one embodiment, the AdInteractive Menu module 1410 can be configured to receive interactive menu configuration information from a user, such as an advertiser, using a graphical user interface 1414 inside a video window. In one embodiment, the graphical user interface can be an interactive pop up window. In another embodiment, the graphical user interface can be accessed through a webpage.

In one embodiment, the graphical user interface 1414 can be configured to receive: menu layout information 1420, menu background image information 1430, menu button selection information 1440, button configuration information 1450, menu button dynamic placement information 1460, menu form association information 1470, and menu coupon association information 1480. In one embodiment, the menu layout information 1420 can include information regarding how to layout a menu of the interactive menu. In another embodiment, the menu background image information 1430 can include information for selecting a background image of the interactive menu. In another embodiment, the menu button selection information 1440 can include information for selecting one or more buttons that can be shown in the interactive menu. For example, the one or more buttons can include buttons for users to view social networks linked to the advertisement, find locations where the advertised product may be available for purchase, view additional videos or advertisements related to the product, and so forth.

In another embodiment, the button configuration information 1450 can include information for customizing an icon and link associated with a button. In another embodiment, the menu button dynamic placement information 1460 can include information for a location of one or more buttons in the interactive menu. In another embodiment, the menu form association information 1470 can include format information and/or content information for an advertising form for viewers of an advertisement to fill out in the interactive menu. In another embodiment, the menu coupon association information 1480 can include coupon information or reward information to display in the interactive menu.

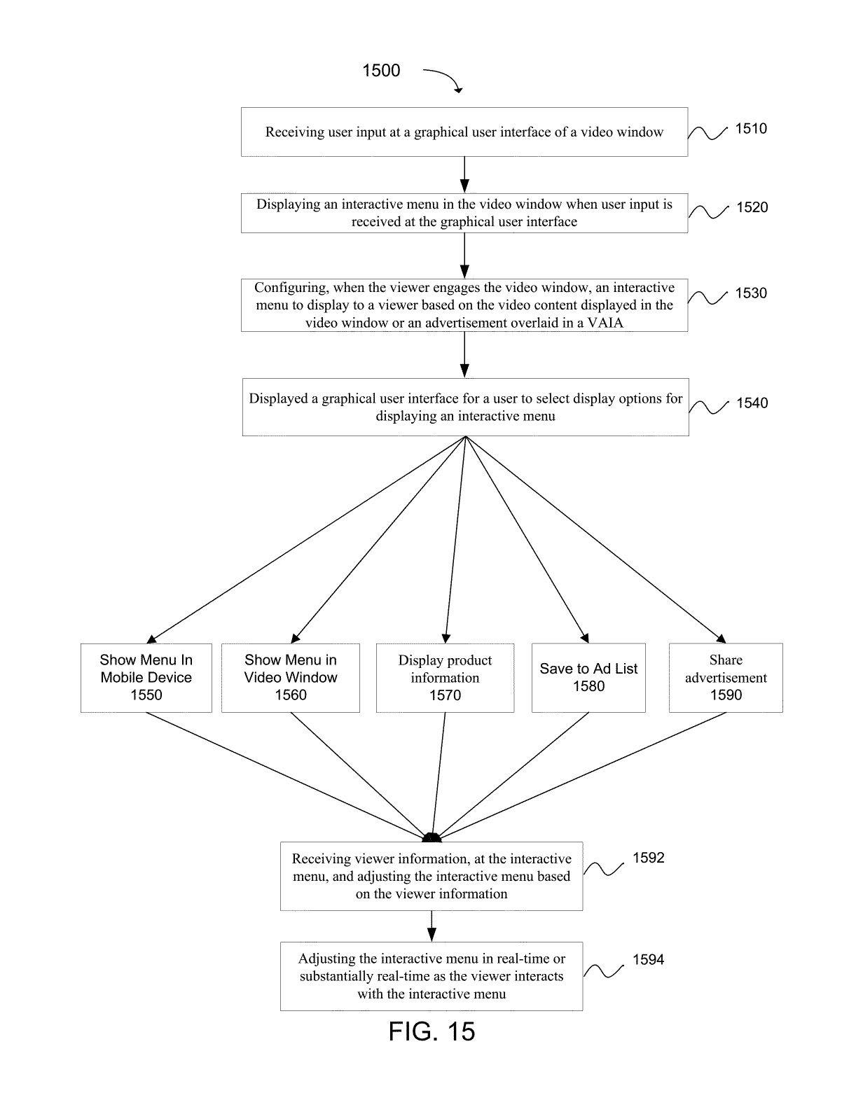

FIG. 15 uses a flow chart 1500 to illustrate a method to configure an interactive menu for a selected video content to the video player. The method can comprise of receiving user input at a graphical user interface of a video window, as shown in block 1510. In one embodiment, the graphical user interface can receive user input when a viewer engages the video window by clicking a mouse, typing on a keyboard, touching a touch screen display in a selected area of video window, setting a pointer on a display screen over the top of an advertisement, and so forth. The method can further comprise displaying an interactive menu in the video window when user input is received at the graphical user interface, as shown in block 1520. In one embodiment, the interactive menu can be displayed at the location the viewer engaged the video window or adjacent to the location the viewer engaged the video window. In another embodiment, the interactive menu can be a graphical user interface. In another embodiment, the interactive menu can be a displayed in a pop-up window.

In another embodiment, the method can further comprise configuring, when the viewer engages the video window, an interactive menu to display to a viewer based on the video content displayed in the video window or an advertisement overlaid in a VAIA, as shown in block 1530. In another embodiment, the method can further comprise displayed a graphical user interface for a user to select display options for displaying an interactive menu, as shown in block 1540. In one embodiment, the display options can include a send to mobile device option, a show option, an additional information option, a share advertisement option, and a save to ad list option. In one embodiment, the method can further comprise displaying an interactive menu on a selected mobile computing device when a viewer selects the send to mobile device option, as shown in block 1550. In one example, the user can continue watching the video content in the video window, e.g. without interruptions from advertising, and use the mobile device as a second screen for viewing the advertisements. In one embodiment, the method can further comprise displaying the interactive menu in the video window when a viewer selects the show option, as shown in block 1560.

In one embodiment, the method can further comprise displaying product information about a product in an advertisement when a viewer selects the additional information option, as shown in block 1570. The product information can include brand information about the product, directions to the nearest store to purchase the product, links to social network sites about the product, detailed product information, additional advertisement content, and so forth. In one embodiment, the method can further comprise saving the advertisement to a save list when a viewer selects the save to ad list option, as shown in block 1580. In one embodiment, the save list can include content objects, such as video, pictures, or audio clips, saved by a viewer for viewing at a later period of time and on a selected device. In another embodiment, the save list can include additional product information saved by a viewer for viewing at a later period of time.

In one embodiment, the method can further comprise guiding the viewer to an other interactive menu to send the advertisement to an other user when a viewer selects a share advertisement option, as shown in block 1590. For example, the viewer can select a share button in the interactive menu and the interactive menu can guide the viewer to a graphical user interface to share the AD using email, a short message service (SMS), a social network platform such as Facebook or Twitter, and so forth. In one embodiment, the method can further comprise receiving viewer information, at the interactive menu, and adjusting the interactive menu based on the viewer information, as shown in block 1592. In one embodiment, the method can further comprise adjusting a menu layout, a user interface, and/or a display option of the interactive menu based on the received viewer information. In one embodiment, the method can further comprise adjusting the interactive menu in real-time or substantially real-time as the viewer interacts with the interactive menu, as shown in block 1594. In another embodiment, the method can further comprise customizing the interactive menu in real-time or substantially real-time based on the video content and/or a viewer profile. In one embodiment, the interactive menu can be adjusted using a web-interface editing tool, as discussed preceding paragraphs for FIG. 14.

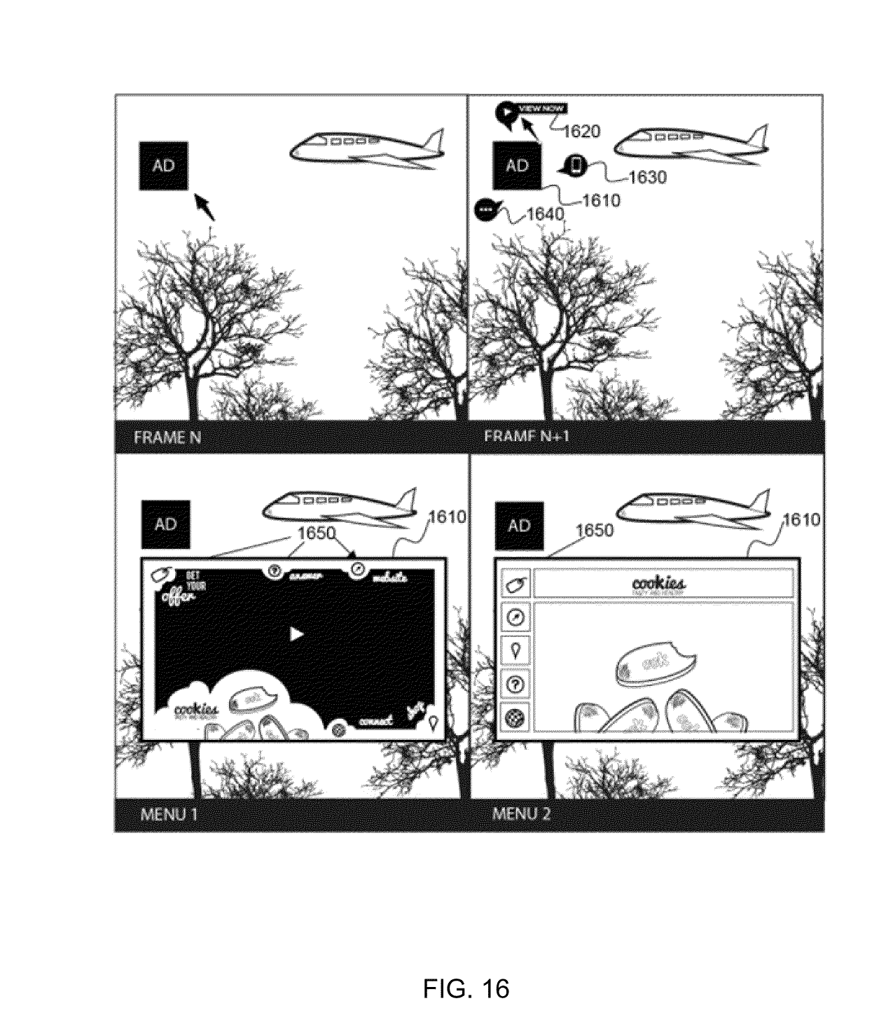

FIG. 16 shows time lapsed Frames N, N−1, MENU 1, and MENU 2 of a video content with an interactive menu 1610. At Frame N, a viewer interacts with the advertisement by touching or clicking the AD. At Frame N+1, the interactive menu 1610 displays a menu with options to watch the advertisement now 1620, watch the advertisement later 1640, or send advertisement to another device 1630. In one embodiment, the viewer can select to continue to watch the video content. For example, the viewer can click on an area of the video window other than the AD or the interactive menu 1610. In one example, when the viewer is interested in watching the advertisement at a later time, the viewer can use the interactive menu to select to send the advertisement to watch at a mobile device by selecting the send advertisement to another device option 1640. In another example, when the viewer desires to watch the advertisement at a later time the viewer can use the interactive menu to select the watch the advertisement later option 1640. When the watch the advertisement later option 1630 is selected, the interactive menu can save the advertisement to an AD list to later retrieve and watch the advertisement. Frame MENU 1 shows one example of a user selecting the to watch the advertisement now option 1620. Frame MENU 1 further shows a graphical user interface, such as pop-up window, to display a commercial and additional menu options 1650, such as a button linking to a product website, a button linking to a product purchase interface, a button linking to customer service help, and so forth. In one embodiment, the additional menu options 1650 can be preconfigured and changed by an advertiser in real time or substantially real time using a graphical user interface, such as discussed in the preceding paragraphs for FIG. 14. Frame MENU 2 shows another example a graphical user interface for a viewer that selects the watch the advertisement now option 1620 and additional menu options 1650.

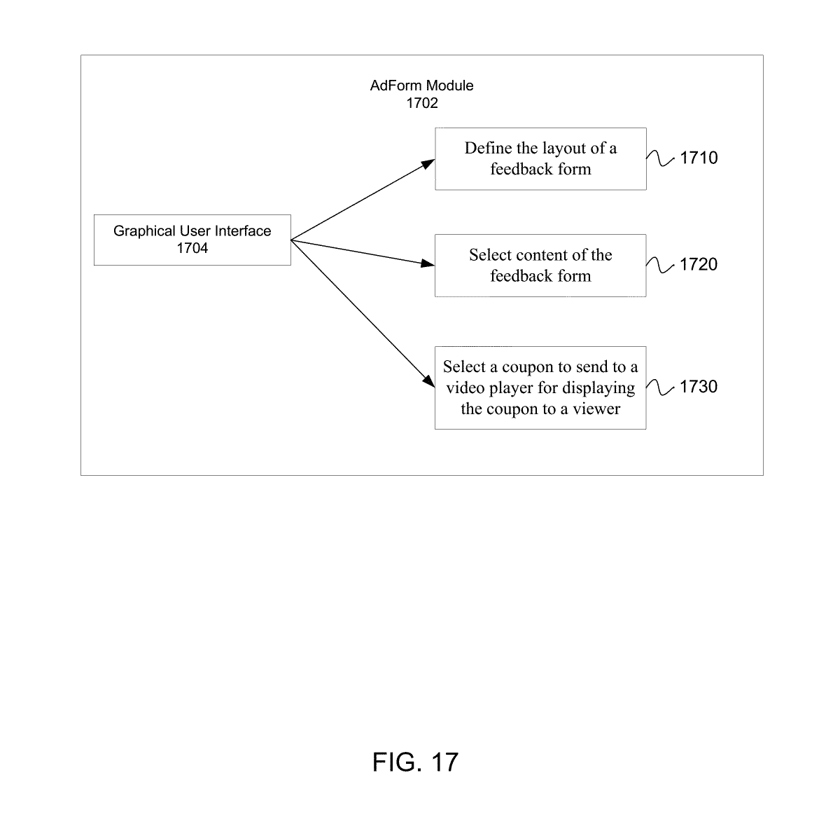

FIG. 17 illustrates an AdForm module 1702 of the advertisement insertion system, as shown in FIG. 1, that is operable to configure a feedback form. In one embodiment, the AdForm module 1702 can provide a graphical user interface 1704 for an advertiser to configure the feedback form. In one embodiment, the graphical user interface can be part of a webpage. In one embodiment, the graphical user interface 1704 can be configured to define the layout of a feedback form, as shown in block 1710. In another embodiment, the graphical user interface 1704 can be configured to select content of the feedback form, as shown in block 1720. In one embodiment, the graphical user interface 1704 can be configured to select a coupon to send to a video player for displaying the coupon to a viewer, as shown in 1730. In one embodiment, the AdForm Module can be configured to construct the feedback form in a webpage using a webpage editing tool. In one embodiment, the AdForm module can be configured to receive content selection information from a user, such as an advertiser, using the graphical user interface 1704, wherein the content selection information can be used to select the content of the feedback form and/or the feedback incentive presented to a viewer.

In one embodiment, the video player of the advertisement insertion system can be configured to display the feedback form to a viewer to receive selected feedback from a viewer. In one embodiment, the advertisement form can be a survey, a questionnaire, a contest, and so forth. In one embodiment, the advertisement insertion system can be configured to receive feedback information using a graphical user interface to receive user input feedback information. For example, the feedback form can be displayed at the graphical user interface 1704 and the viewer can use an input device, such as a mouse or keyboard of a computing device, to fill out the feedback form. In one embodiment, the video player can display a feedback incentive, such as a coupon or reward, to the viewer as a reward for filling out a feedback form. In another embodiment, the video player can display a feedback incentive, such as a coupon or reward, without the viewer filling out a feedback form, e.g. a free coupon or reward. In one embodiment, the advertisement insertion system can be configured to use the feedback forms, such as a survey or questionnaire from an advertiser, to gather feedback information from a viewer. In one embodiment, the feedback forms can be selected based on advertisements and/or video content displayed by the video player. In one embodiment, an advertiser can select the feedback form and/or feedback incentive using a graphical user interface 1704 of the AdForm module.

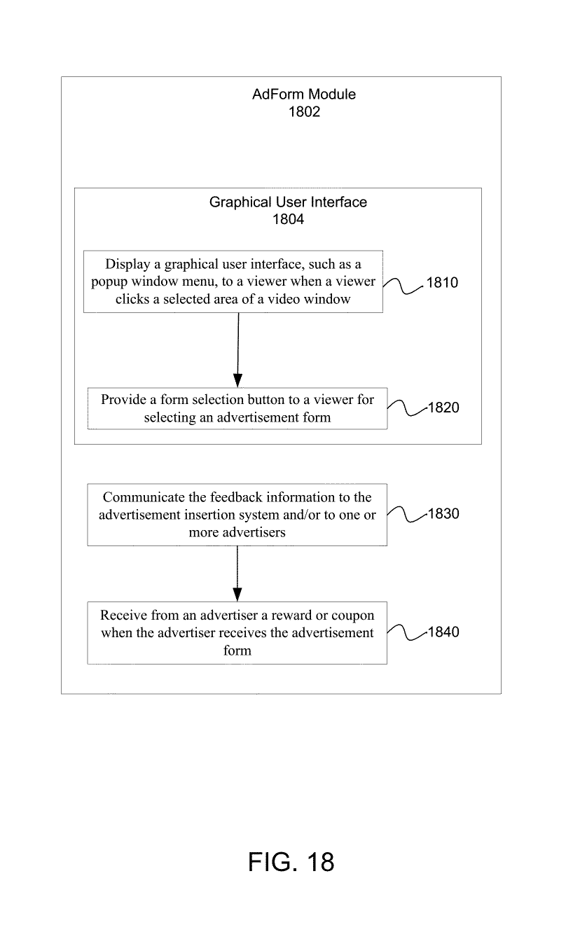

FIG. 18 illustrates an AdForm module 1802 of the advertisement insertion system, as shown in FIG. 1, that is operable to display a graphical user interface 1804 to a viewer for the viewer interact with an advertisement. In one embodiment, the AdForm module 1802 can be configured to display a graphical user interface 1804, such as a popup window menu, to a viewer when a viewer clicks a selected area of a video window, as shown in block 1810. In one embodiment, the graphical user interface 1804 can be configured to provide a form selection button to a viewer for selecting an advertisement form, as shown in block 1820. In another embodiment, the AdForm module 1802 can be configured to receive feedback information that is input by the viewer using the graphical user interface 1804. In one embodiment, the AdForm module 1802 can be configured to communicate the feedback information to the advertisement insertion system and/or to one or more advertisers, as shown in block 1830. In one embodiment, the AdForm module 1802 can be configured to receive from an advertiser a reward or coupon when the advertiser receives the advertisement form, as shown in block 1840.

In one embodiment, the AdEmbedder module can be configured to overlay advertisements and/or advertisement format sequences in one or more VAIAs of a video content. In another embodiment, the AdEmbedder module can be configured to communicate the video content with the overlaid advertisements to a video player to be displayed to a viewer.

In one embodiment, the AdEmbedder module can insert the advertisements into the video content. In one embodiment, the AdEmbedder module can insert the advertisements into the video content by flattening the advertisements onto the video content. One advantage of inserting the advertisements by flattening the advertisements on the video content can be to fit the advertisements into time and space available in video content.

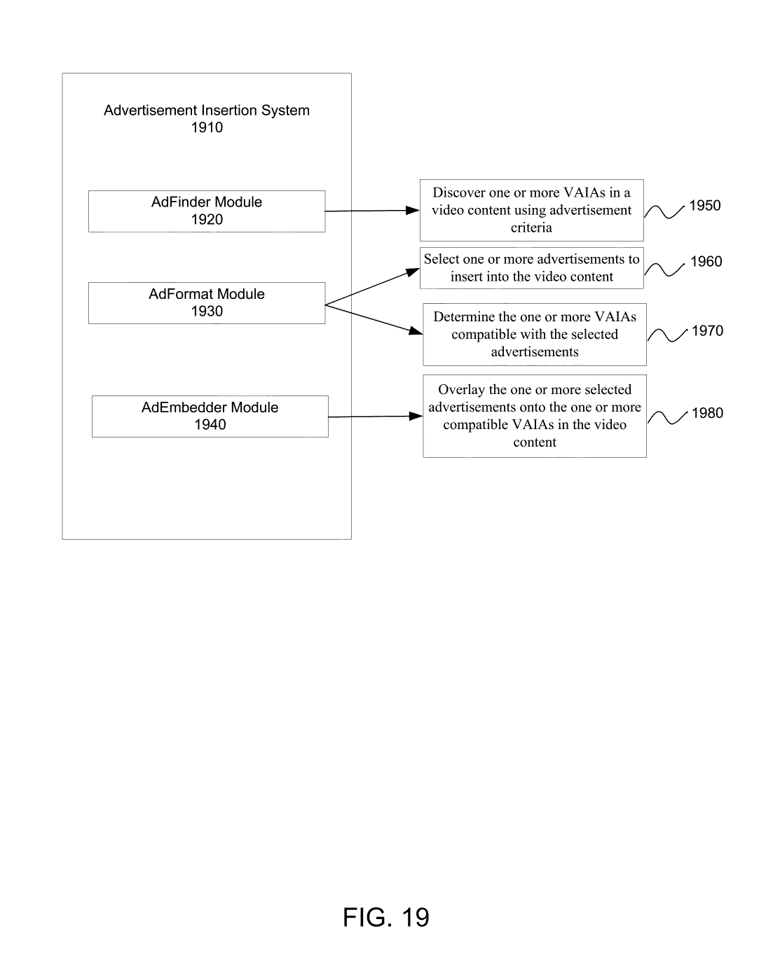

FIG. 19 shows an advertisement insertion system 1910 for dynamically inserting an advertisement into video content. The advertisement insertion system 1910 can include an AdFinder module 1920 configured to discover one or more viable advertisement insertion areas (VAIAs) in a video content using advertisement criteria, as shown in block 1950. The advertisement insertion system 1910 can include an AdFormat module 1930 configured to select one or more advertisements or advertisement sequences to insert into the video content, as shown in block 1960. The AdFormat module 1930 can further be configured to determine the one or more VAIAs compatible with the selected advertisements, as shown in block 1970. The advertisement insertion system 1910 can include an AdEmbedder module 1940 configured to overlay the one or more selected advertisements onto the one or more compatible VAIAs in the video content, as shown in block 1980.

In one embodiment, the advertisement insertion system 1910 can further comprising a display screen configured to display the video content from the video player 1940 with the one or more inserted advertisements. In another embodiment, the advertisement insertion system 1910 can further comprising an AdForm module configured to construct a feedback form using feedback form criteria. In another embodiment, the AdForm Module can be further configured to receive user input, using a graphical user interface, for selecting the feedback form criteria. In one embodiment, the feedback form criteria can include short questions, long questions, multiple choice questions, and so forth. In another embodiment, the AdForm Module can be configured to receive user feedback for the feedback form using a graphical user interface and distribute a reward or coupon to a user when the user feedback is received for the feedback form. In another embodiment, the AdFormat module 1930 can be configured to determine a sequence of the one or more advertisements, wherein the one or more advertisements are linear advertisements and non-linear advertisements.

In one embodiment, the advertisement criteria can include an advertisement minimum exposure time, a VAIA size range, and a number of VAIAs simultaneously available to insert advertisements. In another embodiment, the AdFinder module 1920 can comprise a graphical user interface configured to receiving user input for selecting one or more the advertisement criteria. In another embodiment, the advertisement insertion system 1910 can further comprising: an AdInteractiveMenu module configured to determine interactive menu criteria of an interactive menu, wherein the interactive menu criteria include a interactive menu layout, a user interface layout, and display options for the interactive menu; and the video player 1940 can be configured to insert the configured interactive menu into the video content.

In one embodiment, the interactive menu can be further configured to dynamically adjust the interactive menu based on the one or more advertisements to insert into the video content. In one embodiment, the interactive menu can be further configured to receive user input, using a graphical user interface, for selecting one or more of the interactive menu criteria. In another embodiment, the interactive menu can include a watch the advertisement now option, a watch the advertisement later option, and a send the advertisement to a mobile device option. In another embodiment, the video player 1940 can be a web-based video player.

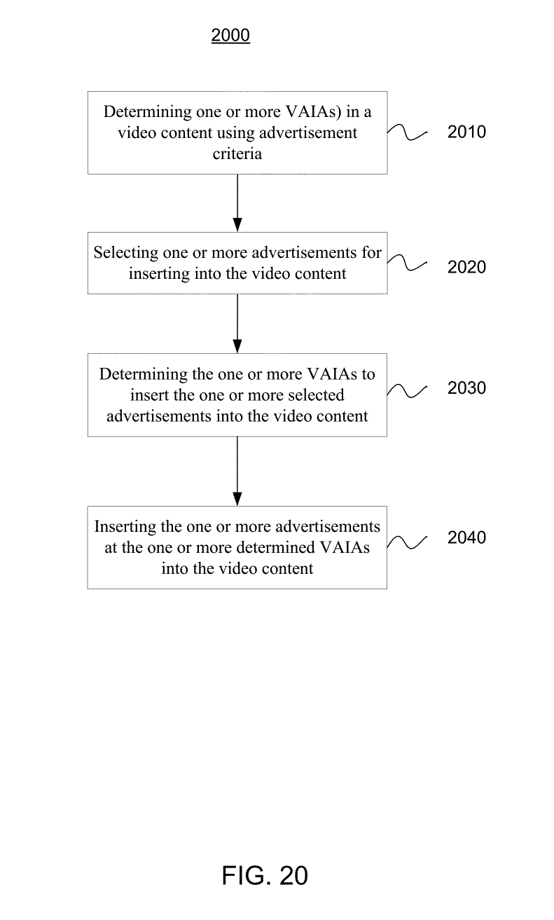

FIG. 20 uses a flow chart 2000 to illustrate a method for dynamically inserting an advertisement into video content at an advertisement insertion system. The method can comprise determining one or more viable advertisement insertion areas (VAIAs) in a video content using advertisement criteria, as in block 2010. The method can further comprise selecting one or more advertisements for inserting into the video content, as in block 2020. The method can further comprise determining the one or more VAIAs to insert the one or more selected advertisements into the video content, as in block 2030. The method can further comprise inserting the one or more advertisements at the one or more determined VAIAs into the video content, as in block 2040.

In one embodiment, the method can further comprise receiving, at a video player, an advertising sequence of linear advertisements and/or non-linear advertisements. In one embodiment, the advertising sequence can include non-linear advertisements sequences inserted within linear advertisement sequences. In another embodiment, the advertising sequence can include a pre-roll advertisement video, an advertisement video, and a post-roll advertisement video. In another embodiment, the pre-roll advertisement video, advertisements video, or post-roll advertisement video can contain advertisements inserted into the one or more VAIAs. In another embodiment, the one or more advertisements can be video content, web 3D objects, static images, or animated images. In another embodiment, the method can further comprise aligning each advertisement with a center of each determined VAIA. In another embodiment, the method can further comprise: detecting a pending collision of an advertisement and a dominant object; selecting, when the pending collision is detected, an other VAIA using priority criteria to insert the advertisement to avoid the pending collision; and inserting the advertisement into the other VAIA to avoid the pending collision.

In one embodiment, the priority criteria for selecting the other VAIA can include the VAIA closest to an outer boundary of the pending collision area and the closest to the previous viable area or the VAIA with the largest viable area outside the outer boundary of the pending collision area. In another embodiment, the method can further comprise detecting a pending collision of an advertisement and a relevant and dominant object in the video content; adjusting the size of the VAIA of the advertisement during a collision to avoid a collision of the advertisement and the relevant and dominant object of the video content; and readjusting the size of the VAIA to the initial size of the VAIA before the pending collision. In another embodiment, the method can further comprise detecting a pending collision of an advertisement and a relevant and dominant object in the video content and traversing the advertisement through the dominant object.

In one embodiment, the method can further comprise selecting a VAIA is within the boundaries of a relevant and dominant object and overlaying the advertisement in the VAIA while the relevant and dominant object is within frames of the video content. In another embodiment, the inserted advertisement in the VAIA can be centered relative to the boundaries of the relevant and dominant object. In another embodiment, the method can further comprise detecting a pending collision of an advertisement and a relevant and dominant object in the video content; removing the advertisement from the video content during the pending collision to avoid a collision of the advertisement and the dominant object; and returning the advertisement to the VAIA when the relevant and dominant object has passed the VAIA. In another embodiment, the method can further comprise adapting the advertisement to a perspective, a plane, a rotation, or a size of the VAIA. In one embodiment, the method can further comprise, determine an insertion of one or more advertisements into one or more VAIAs based on an advertiser preference.

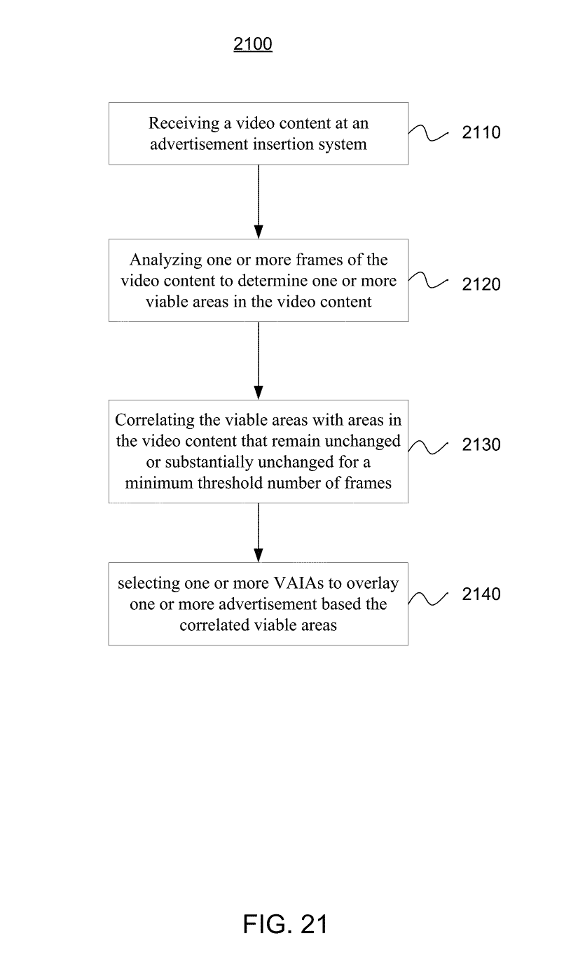

FIG. 21 uses a flow chart 2100 to illustrate a method for calculating a VAIA within video content at an advertisement insertion system. The method can comprise receiving a video content at an advertisement insertion system, as in block 2110. The method can further comprise analyzing one or more frames of the video content to determine one or more viable areas in the video content, wherein a viable area is an area with a size that is equal to or exceeds a threshold minimum advertisement area size and the area does not interfere with dominant objects in the video content, as in block 2120. The method can further comprise correlating the viable areas with areas in the video content that remain unchanged or substantially unchanged for a minimum threshold number of frames, as in block 2130. The method can further comprise selecting one or more VAIAs to overlay one or more advertisement based the correlated viable areas, as in block 2140.

In one embodiment, the method can further comprise selecting one or more VAIAs using placement criteria or using a threshold number of VAIAs that can be displayed simultaneously in a same portion of the video content. In another embodiment, the method can further comprise rejecting viable areas that are below the threshold minimum advertisement area size. In another embodiment, the viable area is an area in the video content that does not collide with a dominant and relevant object and does not compromise an action or motion of the video content. In another embodiment, the method can further comprise analyzing the video content frame by frame to determine one or more viable areas in the video content. In another embodiment, the method can further comprise: analyzing only selected frames of the video content to determine one or more viable areas in the video content; pairing corresponding areas of the non-selected frames with the viable areas of the selected frames; correlating the paired viable areas with areas in the video content that remain unchanged or substantially unchanged for a minimum threshold number of frames; and selecting one or more VAIAs to overlay one or more advertisement based the correlated viable areas.

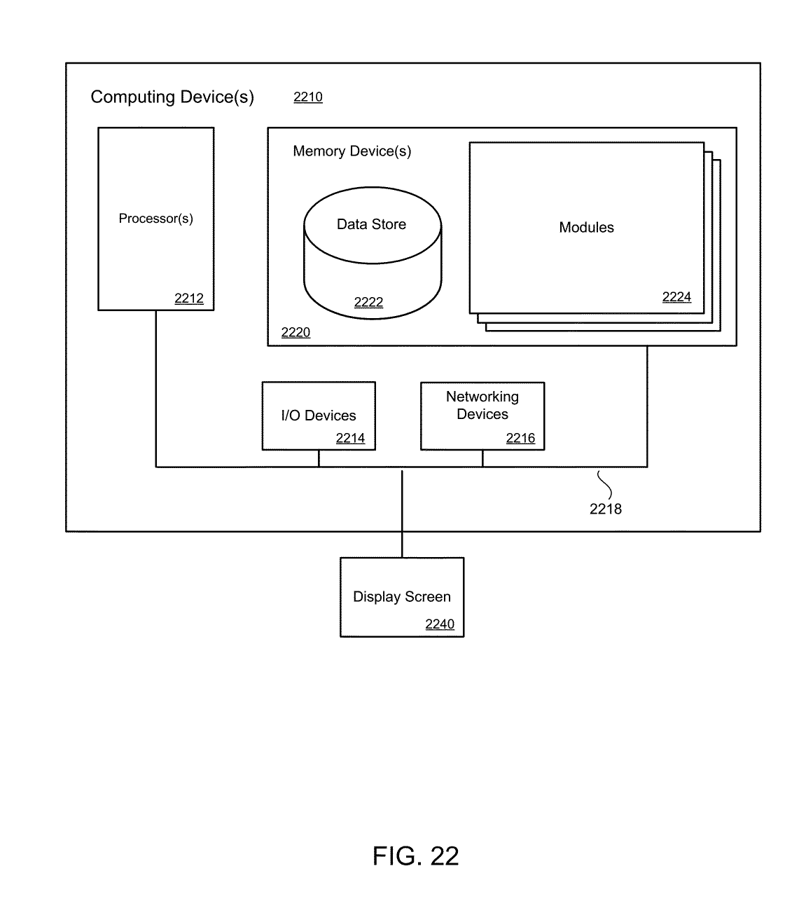

FIG. 22 illustrates a computing device 2210 on which modules of this technology may execute. A computing device 2210 is illustrated on which a high level example of the technology may be executed. The computing device 2210 may include one or more processors 2212 that are in communication with memory devices 2220. The computing device 2210 may include a local communication interface 2218 for the components in the computing device. For example, the local communication interface 2218 may be a local data bus and/or any related address or control busses as may be desired.

The memory device 2220 may contain modules that are executable by the processor(s) 2212. In one example, the memory device 2220 may contain a quantity extraction module, prediction module, quantity refinement module, index module and other modules that may be located in the memory device 2220. The modules 2224 may execute the functions described earlier. A data store 2222 may also be located in the memory device 2220 for storing data related to the modules and other applications along with an operating system that is executable by the processor(s) 2212.

Other applications may also be stored in the memory device 2220 and may be executable by the processor(s) 2212. Components or modules discussed in this description that may be implemented in the form of software using high programming level languages that are compiled, interpreted or executed using a hybrid of the methods.

The computing device may also have access to I/O (input/output) devices 2214 that are usable by the computing devices. An example of an I/O device is a display screen 2240 that is available to display output from the computing devices. Other known I/O device may be used with the computing device as desired. Networking devices 2216 and similar communication devices may be included in the computing device. The networking devices 2216 may be wired or wireless networking devices that connect to the Internet, a LAN, WAN, or other computing network.

The components or modules that are shown as being stored in the memory device 2220 may be executed by the processor(s) 2212. The term “executable” may mean a program file that is in a form that may be executed by a processor 2212. For example, a program in a higher level language may be compiled into machine code in a format that may be loaded into a random access portion of the memory device 2220 and executed by the processor 2212, or source code may be loaded by another executable program and interpreted to generate instructions in a random access portion of the memory to be executed by a processor. The executable program may be stored in any portion or component of the memory device 2220. For example, the memory device 2220 may be random access memory (RAM), read only memory (ROM), flash memory, a solid state drive, memory card, a hard drive, optical disk, floppy disk, magnetic tape, or any other memory components.

The processor 2212 may represent multiple processors and the memory 2220 may represent multiple memory units that operate in parallel to the processing circuits. This may provide parallel processing channels for the processes and data in the system. The local interface 2218 may be used as a network to facilitate communication between any of the multiple processors and multiple memories. The local interface 2218 may use additional systems designed for coordinating communication such as load balancing, bulk data transfer and similar systems.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Reference was made to the examples illustrated in the drawings, and specific language was used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

What is claimed is:

1. An advertisement insertion system for dynamically inserting an advertisement into video content, the advertisement insertion system comprising:
an AdFinder module configured to discover one or more viable advertisement insertion areas (VAIAs) in a video content using advertisement criteria;
an Ad Format module configured to:
select one or more advertisements to insert into the video content; and
determine the one or more VAIAs compatible with the selected advertisements; and
an AdEmbedder module configured to overlay the one or more selected advertisements onto the one or more compatible VAIAs in the video content.

2. The advertisement insertion system of claim 1, further comprising an AdForm module configured to construct a feedback form using feedback form criteria.

3. The advertisement insertion system of claim 2, wherein the AdForm Module is further configured to receive user input, using a graphical user interface, for selecting the feedback form criteria.

4. The advertisement insertion system of claim 3, wherein the AdForm Module is configured to:
receive user feedback for the feedback form using a graphical user interface; and
distribute a reward or coupon to a user when the user feedback is received for the feedback form.

5. The advertisement insertion system of claim 1, further comprising the AdFormat module configured to determine a sequence of the one or more advertisements, wherein the one or more advertisements are linear advertisements and non-linear advertisements.

6. The advertisement insertion system of claim 1, wherein the advertisement criteria include:
an advertisement minimum exposure time;
a VAIA size range; and
a number of VAIAs simultaneously available to insert advertisements.

7. The advertisement insertion system of claim 6, wherein the AdFinder module further comprise a graphical user interface configured to receive user input for selecting one or more the advertisement criteria.

8. The advertisement insertion system of claim 1, further comprising:
an AdInteractiveMenu module configured to determine interactive menu criteria of an interactive menu, wherein the interactive menu criteria include an interactive menu layout, a user interface layout, and display options for the interactive menu; and
the AdEmbedder module is further configured to insert the configured interactive menu into the video content.

9. The advertisement insertion system of claim 8, wherein the interactive menu is further configured to dynamically adjust the interactive menu based on the one or more advertisements to insert into the video content.

10. The advertisement insertion system of claim 8, wherein the interactive menu is further configured to receive user input, using a graphical user interface, for selecting one or more of the interactive menu criteria.

11. The advertisement insertion system of claim 8, wherein the interactive menu includes a watch the advertisement now option, a watch the advertisement later option, and a send the advertisement to a mobile device option.

12. A method for dynamically inserting an advertisement into video content at an advertisement insertion system, the method comprising:
determining one or more viable advertisement insertion areas (VAIAs) in a video content using advertisement criteria;
selecting one or more advertisements for inserting into the video content;
determining the one or more VAIAs to insert the one or more selected advertisements into the video content; and
inserting the one or more advertisements at the one or more determined VAIAs into the video content.

13. The method of claim 12, further comprising receiving, at a video player, an advertising sequence of linear advertisements and non-linear advertisements.

14. The method of claim 13, wherein the video player is a web-based video player.

15. The method of claim 13, wherein the advertising sequence includes:
a pre-roll advertisement video;
an advertisement video; and
a post-roll advertisement video,
wherein a pre-roll advertisement video, advertisements video, or a post-roll advertisement video contain advertisements inserted into the one or more VAIAs.

16. The method of claim 12, wherein the one or more advertisements are video content, web 3D objects, static images, or animated images.

17. The method of claim 12, further comprising aligning each advertisement with a center of each determined VAIA.

18. The method of claim 12, further comprising:
detecting a pending collision of an advertisement and a dominant object;
selecting, when the pending collision is detected, an other VAIA using priority criteria to insert the advertisement to avoid the pending collision; and
inserting the advertisement into the other VAIA to avoid the pending collision.

19. The method of claim 18, wherein the priority criteria for selecting the other VAIA includes:
a VAIA closest to an outer boundary of the pending collision area and closest to the previous viable area; or
a VAIA with a largest viable area outside the outer boundary of the pending collision area.

20. The method of claim 12, further comprising:
detecting a pending collision of an advertisement and a relevant and dominant object in the video content;
adjusting a size of the VAIA of the advertisement during a collision to avoid a collision of the advertisement and a relevant and dominant object of the video content; and
readjusting the size of the VAIA to an initial size of the VAIA before the pending collision.

21. The method of claim 12, further comprising:
detecting a pending collision of an advertisement and a relevant and dominant object in the video content; and
traversing the advertisement through a dominant object.

22. The method of claim 12, further comprising:
selecting a VAIA is within boundaries of a relevant and dominant object; and
overlaying the advertisement in the VAIA while the relevant and dominant object is within frames of the video content.

23. The method of claim 22, wherein the inserted advertisement in the VAIA is centered relative to the boundaries of the relevant and dominant object.

24. The method of claim 12, further comprising:
detecting a pending collision of an advertisement and a relevant and dominant object in the video content;
removing the advertisement from the video content during the pending collision to avoid a collision of the advertisement and the dominant object; and
returning the advertisement to the VAIA when the relevant and dominant object has passed the VAIA.

25. The method of claim 12, further comprising adapting the advertisement to a perspective, a plane, a rotation, or a size of the VAIA.

26. A method for calculating a viable advertisement insertion area (VAIA) within video content at an advertisement insertion system, the method comprising:
receiving a video content at an advertisement insertion system;
analyzing one or more frames of the video content to determine one or more viable areas in the video content, wherein a viable area is an area with a size that is equal to or exceeds a threshold minimum advertisement area size and the area does not interfere with dominant objects in the video content;
correlating the viable areas with areas in the video content that remain unchanged or substantially unchanged for a minimum threshold number of frames; and
selecting one or more VAIAs to overlay one or more advertisement based the correlated viable areas.

27. The method of claim 26, further comprising selecting one or more VAIAs using placement criteria or using a threshold number of VAIAs that can be displayed simultaneously in a same portion of the video content.

28. The method of claim 26, further comprising rejecting viable areas that are below the threshold minimum advertisement area size.

29. The method of claim 26, wherein the viable area is an area in the video content that does not collide with a dominant and relevant object and does not compromise a action or motion of the video content.

30. The method of claim 26, further comprising analyzing the video content frame by frame to determine one or more viable areas in the video content.

31. The method from claim 30, further comprising:
analyzing only selected frames of the video content to determine one or more viable areas in the video content;
pairing corresponding areas of non-selected frames with viable areas of the selected frames;
correlating the paired viable areas with areas in the video content that remain unchanged or substantially unchanged for a minimum threshold number of frames; and
selecting one or more VAIAs to overlay one or more advertisement based the correlated viable areas.
